(19) United States
(12) Patent Application Publication
(10) Pub. No.: US 2025/0384470 A1
(43) Pub. Date: Dec. 18, 2025

(54) MERCHANT-CUSTOMER AUGMENTED REALITY ENGAGEMENT SYSTEM

(71) Applicant: Erick Lester Brown, Washington, DC (US)

(72) Inventor: Erick Lester Brown, Washington, DC (US)

(21) Appl. No.: 19/234,719

(22) Filed: Jun. 11, 2025

Related U.S. Application Data
(60) Provisional application No. 63/658,995, filed on Jun. 12, 2024.

(51) Int. Cl. G06Q 30/0241; G06Q 30/0251; G06Q 30/0601

(52) U.S. Cl. CPC G06Q 30/0277; G06Q 30/0253; G06Q 30/0254; G06Q 30/0261; G06Q 30/0267; G06Q 30/0276; G06Q 30/0609; G06Q 30/0643

(57) ABSTRACT

In an illustrative embodiment, systems and methods for an augmented reality (AR) system enable merchant-to-customer engagement through context-aware digital content placement. In an embodiment, one element of the system allows merchants to upload, customize, and place AR media objects, and another element allows customers to discover and interact with said content in real-world environments. In an embodiment, another element of the system dynamically ranks and serves AR content based on user behavior, demographics, time, and location. In alternative embodiments, an artificial intelligence engine dynamically generates personalized AR media objects based on real-time user preferences, history, and environmental context. In some embodiments, features include interactive merchant storefronts, digital promotions, real-time analytics, user rewards, breadcrumb-based AR trails, and dynamically personalized AR experiences to encourage repeated engagement.

### CROSS REFERENCE TO RELATED APPLICATIONS

This application claims the benefit of U.S. provisional application Ser. No. 63/658,995, filed Jun. 12, 2024 and entitled Merchant-Customer Augmented Reality Engagement System, the entirety of which is incorporated by reference herein.

### BACKGROUND

Brick-and-mortar merchants of all sizes find it valuable to maintain an online presence. This can include creating their own custom website, making information available to address locator systems such as Google Maps and Apple Maps, and making sure they appear on aggregator/review sites such as Google, Yelp, and TripAdvisor.

Keeping a custom website current can be an expensive and/or time-consuming task. Aggregators and map functions may offer paid sponsor placement, but these are generally not easy to manage and have little to guarantee that the placements effectively reach a target audience.

From a customer perspective, map functions, websites, and aggregators are all useful, but are more useful when a customer knows exactly what business they are seeking. The experience for a browsing customer is typically one of bouncing inefficiently back and forth between mapping apps, browser pages, and aggregator apps.

### SUMMARY OF ILLUSTRATIVE EMBODIMENTS

In some embodiments, augmented reality systems and methods for matching merchants and customers are described. The system in at least some embodiments includes a server-based system for storing and managing merchant and customer data and engaging with a plurality of mobile computing devices, each of which runs an augmented reality application (the merchants and customers can each interact with the system via a same app, or via different apps with different interfaces).

In some embodiments, the merchant app/interface allows each merchant to drive customer engagement through a set of easy-to-control Augmented Reality (AR) placements, ads, promotions, and events, as well as to create a “storefront” with various types of media, including interactive and AR media objects. Many other valuable, but optional features allow each merchant to tune the experience that the system presents to customers, and receive feedback as to how their promotions are reaching customers.

In some embodiments, the customer app/interface allows each customer to tailor their merchant/discovery experience through a variety of features that make the app engaging and useful. For instance, the customer app can sense the customer's surroundings through a sensed feed (using cameras on a smartphone, connected devices such as AR glasses, and location/position sensing), and serve AR merchant placements for merging onto the device display. Thus, a merchant can use the system to set different AR objects to appear on a sidewalk outside their establishment, at the corner of the block, in the business window or doorway, or even in locations interior to the business. The objects can vary depending on time of day, day of week, customer demographics, etc. A customer using the customer app will see, superimposed on their display, AR objects that are tailored to their interests (including individual interests learned by the system over time, current search interests, or new experiences that others of similar preferences have sought—this can include demographic knowledge learned by the system, as well as the preferences of those either followed by or who follow a particular user of the system). The user can also leave feedback/reviews that are both useful to other users, as well as helping the system promote useful information to the user in the future.

The foregoing general description of the illustrative implementations and the following detailed description thereof are merely exemplary aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 is a block diagram of an example environment for a merchant/customer augmented reality system according to an embodiment;

FIG. 2 illustrates customer and merchant database information used by the system of FIG. 1, stored in a database;

FIGS. 3A and 3B illustrate, respectively, home functions for mobile application interfaces for a customer and a merchant;

FIGS. 4 and 5 illustrate, respectively, high-level merchant and customer capabilities accessed through a mobile application interface;

FIG. 6 shows merchant user interface screens for setting/viewing merchant profile information;

FIGS. 7A-7G show merchant user interface screens for creating and managing AR media for a merchant account;

FIG. 8 illustrates merchant business screens that show how a merchant appears to a customer in a mobile application;

FIGS. 9A-9M show mobile application display screens for creating, managing, and viewing merchant ads, promotions, and events;

FIGS. 10A-10D illustrate mobile application display screens for creating, managing, and viewing merchant gifts and donation campaigns;

FIGS. 11A-11F illustrate mobile application display screens that allow a merchant to access statistics regarding various types of user engagement with their merchant page;

FIGS. 12A-12G illustrate mobile application display screens that allow a customer to view/customize various aspects of a customer account;

FIGS. 13A-13E illustrate mobile application display screens for a variety of proximity-dependent content displayed to a customer for nearby merchants;

FIG. 14 shows a customer reward mobile application display screen showing rewards earned by the customer for purchases and interactions with the system;

FIGS. 15A-Q illustrate mobile application display screens that allow a merchant to set up breadcrumb contests;

FIGS. 16A-I illustrate mobile application display screens that allow customers to participate in breadcrumb contests set up by a merchant; and

FIG. 17 illustrates a block diagram for a portable hardware device such as a smartphone or VR system useful for interacting with the augmented reality system.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Aspects of the present disclosure are directed to an integrated augmented reality merchant-to-customer engagement system. In some embodiments, the system is configured to support merchant accounts and customer accounts, each with a corresponding set of features accessible through a mobile application and a set of mobile interfaces. In some examples, the user hardware that supports the interfaces with the system can be a smartphone, tablet, network-connected portable virtual reality (VR) system, or similar device, with a camera, display, and global positioning system (GPS) and position sensors, or similar technology. The system is attractive to merchants in the described embodiments because of the ease with which merchants can create and upload augmented reality content that is accessible to potential customers in the vicinity of their storefront (or inside the store). The system is attractive to customers because of the compelling content that is visually available to a customer as they traverse a merchant area, and the ability of the system to serve that content based on learned user preferences and machine learning from a large pool of customers. For at least these reasons, the implementations of the present disclosure provided herein are a significant improvement over traditional merchant access systems and are necessarily rooted in computer technology.

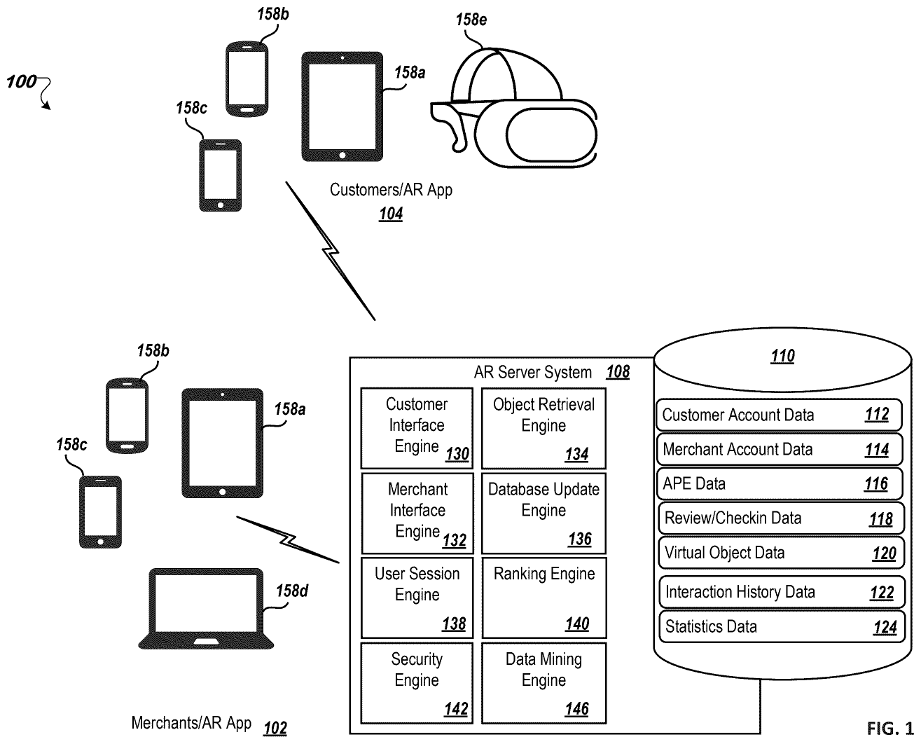

FIG. 1 contains a diagram of an example environment 100 for an augmented reality (AR) merchant/customer system according to an embodiment. The environment 100 includes a merchants/AR application 102, a customers/AR application 104, and an AR server system 108 and database system 110.

Merchants/AR application 102 comprises one or more applications compatible with, e.g., a smart tablet 158a, an Android operating system smartphone 158b, an IoS operating system smartphone 158c, or a Windows, Linux, or MacOS operating system personal computer (laptop computer 158d is shown, but a less portable computer could be used to access at least some features of an AR merchant/customer system). These operating systems are exemplary, but other operating systems such as HarmonyOS, compatible with similar device types as IoS and Android, may also host application 102. Depending on implementation, application 102 can include: separately installed executable code stored on a non-transitory medium on user-compatible hardware; a container with interpretable code that is fed to a compatible execution engine at runtime, the interpretable code stored on a non-transitory medium on user-compatible hardware and/or stored on the AR server system 108 and served to the user-compatible hardware at or just before runtime; and/or browser-based functionality and content that is served by the AR server system 108 to the user-compatible hardware based on browser interaction. For executing AR functionality of the Merchants/AR application 102, application 102 generally will require permission to access a device camera, GPS and position sensors, optionally a microphone, and possibly photos/videos/audio files stored on the user-compatible hardware.

Customers/AR application 104 comprises one or more applications compatible with, e.g., a smart tablet 158a, an Android operating system smartphone 158b, an IoS operating system smartphone 158c, or a VR system 158e. These operating systems are exemplary, but other operating systems such as HarmonyOS, compatible with similar device types as IoS and Android, may also host application 104. Depending on implementation, application 104 can include: separately installed executable code stored on a non-transitory medium on user-compatible hardware; a container with interpretable code that is fed to a compatible execution engine at runtime, the interpretable code stored on a non-transitory medium on user-compatible hardware and/or stored on the AR server system 108 and served to the user-compatible hardware at or just before runtime; and/or browser-based functionality and content that is served by the AR server system 108 to the user-compatible hardware based on browser interaction. For executing AR functionality of the Customers/AR application 104, application 104 generally will require permission to access a device camera, GPS and position sensors, optionally a microphone, and possibly photos/videos/audio files stored on the user-compatible hardware.

In some embodiments, Merchants/AR application 102 and Customers/AR application 104 can reside in a common application (or at least one executable component available to both applications). In such cases, the functionality made available to the user can depend on whether the user is logged in to a merchant account or a customer account.

AR server system 108 can comprise, e.g., software applications or application components that execute on one or more servers and storage devices of an AR server system 108. The system 108 can include dedicated server hardware and/or virtual server hardware that is instantiated on demand using virtual machines (VMs), containers, and/or other runtime environments that execute on hardware located in one or more data centers. The server hardware may be, for instance, owned by the AR system provider and/or hosted on a cloud provider's servers that provides contractual computational services to the AR system provider, including elastic demand features that deploy or retire virtual computer resources depending on the current demand for access to the AR service. In the case of services hosted by a cloud provider, the code base for those services is typically stored on one or more non-transitory storage media devices within the cloud provider's data center(s) and deployed to physical servers as needed. Some engine instances may serve a large number of customers and/or merchants simultaneously; others may be spawned as required to serve a particular request from a particular user, such as an AR presentation session.

In certain embodiments, the functionality of the AR server system 108 can be envisioned as a collection of interoperable engines. For instance, in FIG. 1, AR server system 108 includes a customer interface engine 130, a merchant interface engine 132, an object retrieval engine 134, a database update engine 136, a user session engine 138, a ranking engine 140, a security engine 142, and a data mining engine 146. Each will be described in turn.

Customer interface engine 130 provides for data communications between the customer/AR application 104 deployed on a user device and other engines of the AR server system 108. For instance, when a customer/AR application 104 is launched and becomes a foreground application on a user device, it attempts to contact customer interface engine 130 and establish communications with the AR server system 108. Initial communications may be limited by the customer interface engine 130 to an Application Programming Interface (API) that negotiates with the security engine 142 to establish the privileges and parameters of a user session. Once this negotiation is complete, a user session is instantiated on user session engine 138, and the customer interface engine 130 allows the customers/AR application 104 on the particular device to access API functions that access the user session engine 138.

The customer interface engine 130 may also communicate with a particular customer/AR application 104 on a particular user device when that application is not in the foreground of user interaction. For instance, the customer interface engine 130 may push notifications to a given device, e.g., based on receiving a device location update, or a content update from a merchant that is known to be or indicated to potentially be of interest to a particular user. The customer interface engine 130 may also provide background content refresh or receive device history information from the device when the user is not interacting with the application, as other examples of background operations.

The merchant interface engine 132 functions similar to the customer interface engine 130, e.g., engine 132 provides for data communications between the merchant/AR application 102 deployed on a user device and other engines of the AR server system 108. For instance, when a merchant/AR application 102 is launched and becomes a foreground application on a user device, it attempts to contact merchant interface engine 132 and establish communications with the AR server system 108. Initial communications may be limited by the merchant interface engine 132 to an Application Programming Interface (API) that negotiates with the security engine 142 to establish the privileges and parameters of a user session. Once this negotiation is complete, a user session is instantiated on user session engine 138, and the merchant interface engine 132 allows the merchants/AR application 102 on the particular user device to access API functions that access the user session engine 138.

Unlike the customer interface engine 130, the merchant interface engine 132 generally does not require a wide range of background functionality for optimal operation. The merchant interface engine 132, can, however, perform background functions such as directing particular customer interactions in real time to the user device(s) associated with a particular merchant.

Object retrieval engine 134 interfaces with the data stores of database 110 (to be described next) to retrieve customer and merchant data for the other engines. The parameters supplied to the user session engine 138 provide at least one control over what objects can be retrieved to support a particular user interaction. Some objects may be retrieved based on an explicit request from a user; others may be retrieved based on a current user state and machine learning that configures an artificial intelligence (AI) engine to serve particular content to a particular user based on that current user state, as will be described for various embodiments below. Object retrieval engine 134 may have different priority queues, e.g., AR content for a live AR session receiving a highest priority.

Database update engine 136 manages the storage of information flows from the merchants/AR application 102 and the customers/AR application 104, as well as distilled data from multiple system interactions. Depending on the type of data being updated in database 110, the data may be committed in real-time or queued/merged and updated at select intervals.

User session engine 138, as discussed above, manages the state and information flow for each open merchant or customer session (and may save state information to database 110 for later use). Various types of session activities controlled by the user session engine 138 will become apparent with the discussion of application functionality described regarding the interface figures below. At various times, the user session engine 138 may communicate with any of the other engines.

Ranking engine 140 decides what optional content should be served to a given customer based on their current state, request(s), engagement history, and stored preferences. Ranking engine 140 preferably uses an AI engine that is continuously updated in real-time via machine learning to predict the content most desired by a particular user in a particular geographical location, time of day/week, etc. Various types of ranking activities will become apparent and will be described further when specific functions of the customer/AR application 104 are described below.

Ranking engine 140 interfaces with other engines involved in serving content to each customer's application 104. When the customer's application 104 requests definite information, such as the customer's profile information, link of saved favorites, etc., the ranking engine 140 may not be needed to serve that request. For many other activities, however, the ranking engine 140 will determine what content to serve to the client, and in what order that content will be served when there are multiple content objects to be served. For instance, if a customer is walking through a commercial district and opens the AR interface of their application, the object retrieval engine 134 may pull metadata for the surroundings from database 110, and supply those to ranking engine 140, along with customer-specific information. The ranking engine 140 will then determine ranked objects that will be overlaid on a scene as viewed through a camera/cameras on the user's device, and create instructions for the user's device as to when and where to overlay those objects. The ranking engine 140 may also arrange search results/lists of merchants, offers, etc. in response to direct user queries.

Security engine 142 is responsible for user verification, and for each verified user, specifying what functions and user-specific content is available to that user.

Data mining engine 146 uses information from user interactions to derive statistics for merchants for their various promotions, improve the utility of information served to users, and create group interaction behavioral data that can be used by merchants and advertisers. Certain data may be anonymized as to users and merchants, and based on demographic characteristics of the users and merchants. In some embodiments, users with common characteristics may be gathered into a group and presented the same or coordinated AR content. Common characteristics may include, but are not limited to customer identity data 212, usage history 22, or location, purchases 226, or favorites 224.

Database 110 comprises one or more non-transitory memories, e.g., locally attached to servers of server system 108 or remotely attached to server system 108 by one or more networks, e.g., as storage servers. The memories can comprise magnetic disk drives, solid-state drives, or the like. Network communications between server system 108 and remote storage servers of database 110 may use known protocols for data delivery and storage operations. Remote storage may be in a same data center as a server accessing that data, or accessed from one or more remote locations.

A variety of types of information are stored in database 110, including customer account data 112, merchant account data 114, APE (Advertising, Promotions, and Events) data 116, review/checkin data 118, virtual object data 120, interaction history data 122, and statistics data 124. Each type of data will be discussed in more detail below, in conjunction with examples of how it is used by the server system 108.

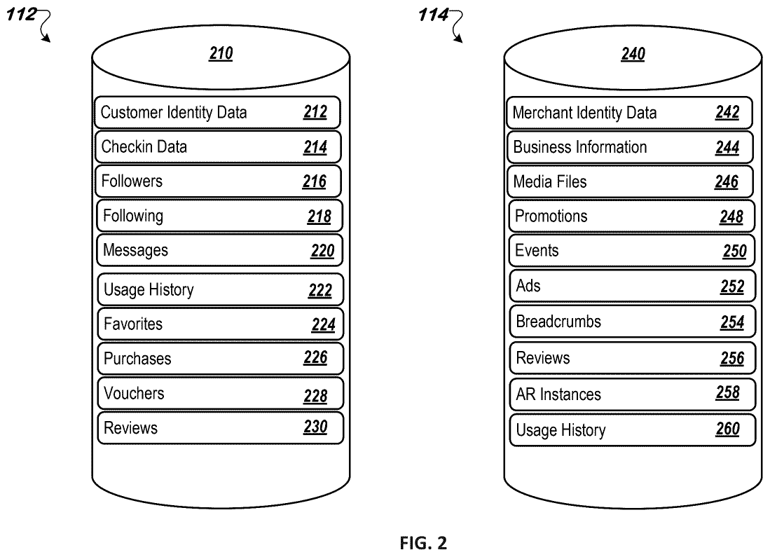

FIG. 2 illustrates a further breakdown of the customer account data 112 and merchant account data 114, as stored for each customer and merchant, respectively, in database entries 210 and 240 keyed to that user. It is noted that not all customers and all merchants will necessarily use all data types and all functionality of a respective account.

For customer accounts, stored customer information includes customer identity data 212, checkin data 214, followers 216, following 218, messages 220, usage history 222, favorites 224, purchases 226, vouchers 228, and reviews 230. Each type of data will be discussed in more detail below, in conjunction with examples of how it is used by the server system 108.

For merchant accounts, stored merchant information includes merchant identity data 242, business information 244, media files 246, promotions 248, events 250, ads 252, breadcrumbs 254, reviews 256, AR instances 258, and usage history 260. Each type of data will be discussed in more detail below, in conjunction with examples of how it is used by the server system 108.

In some embodiments, the AI engine aggregates multiple data inputs from databases 110, 210 and 240, including but not limited to, customer favorites 224, customer preferences, customer identity data 212, history of purchases 222, interaction history data 122, real-time GPS location, and other device inputs. Additional inputs from the a participating merchant may influence the generated AR content, including but not limited to promotions 248, rewards, and events 250.

The AI engine dynamically selects and generates personalized AR content for each given customer. In one embodiment, the AI engine operates through one or more pretrained models updated periodically, or continuously, on collective customer and merchant data. Ongoing customer and merchant interactions refine the AI engine's predictive capabilities and optimize AR content relevance and the ranking engine 140, over time.

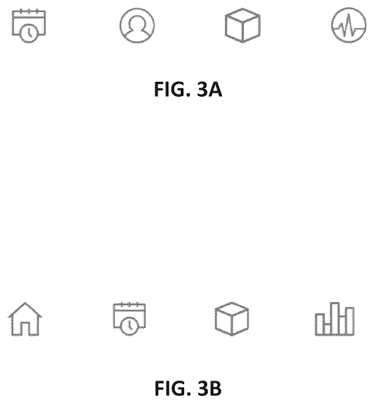

As discussed above, merchants and customers access stored information by interfacing with the AR server system 108 through an AR App 102 or 104. High-level access to functionality can be via traditional menus and icons, with top-level icons such as shown in FIGS. 3A and 3B always accessible in the application. FIG. 3A shows exemplary top-level icons for a customer AR app 104, and FIG. 3B shows exemplary top-level icons for a merchant AR app 102. The use of particular functions triggered by accessing the icons will be explained below.

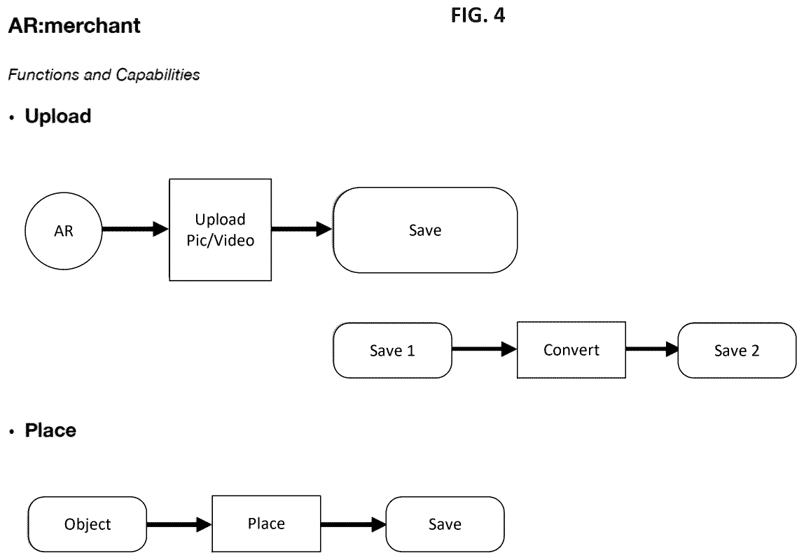

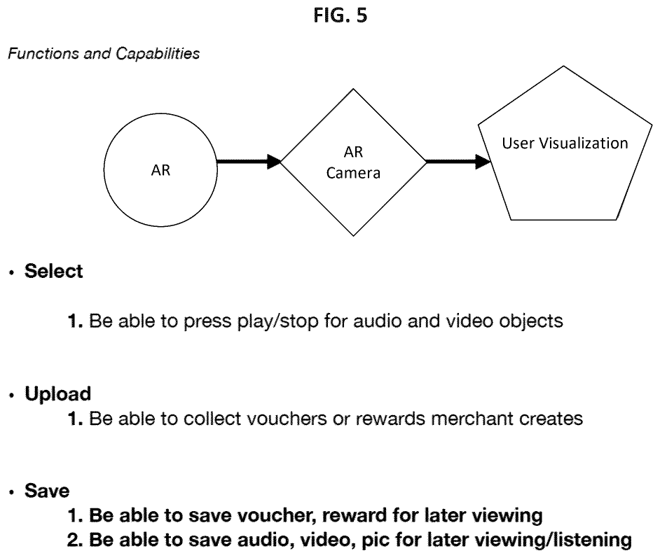

FIG. 4 illustrates functional flow diagrams for a merchant wishing to create an AR object in the system. The merchant first accesses an “Upload” AR function, which prompts the merchant to upload a picture or video of an AR object. The picture or video can be permanently stored on or accessible through the merchant's computing device, or the merchant can indicate that they wish to create the picture or video “live” as part of the upload process. Once uploaded, the system saves the object (“Save”). The system may then perform a conversion process (“Save 1” to “Save 2”) to resize, enhance, or standardize the format of the object for use in the AR system. For instance, one enhancement may be to analyze multiple pictures and/or a video and extract a 3D representation of the uploaded object.

The merchant subsequently accesses a “Place” AR function through the system. If accessed immediately after the “Upload” AR function, the “Place” function may automatically suggest the just-uploaded object, but the merchant may also choose to access any previously saved AR objects in their library. The merchant is then prompted to place the object in or around the merchant's physical location, e.g., by activating the merchant's camera and prompting them to select a location (at a street corner near the store, on or floating above a sidewalk outside a storefront, on a window of the store, in an aisle or shelf inside the store, etc.) for object placement. The merchant may also be asked to scan the surroundings to help the AR system build a context map for the object's location. Other sensors (GPS, compass, orientation sensors, WiFi location) may also be accessed to aid the system in pinpointing the location. The merchant may then be shown a simulation of how the object will appear to customers and be given the chance to approve and save, or make adjustments to location, size, etc., of the AR placement prior to saving.

FIG. 5 illustrates a functional flow diagram for customer interaction with AR content created by merchants. The customer launches the “AR” function of their app. This causes the AR server system 108 to access the customer's preferences, and based on the customer's physical location, rank/select merchant AR objects from one or more merchants that are near that location and of potential interest. The objects and their contextual placement information are downloaded to a cache on the customer's device for use by the “User Visualization” function. As the user continues to move and reorient their viewpoint, the AR server system 108 may continue to update the cache with additional objects and contextual placement information.

Launching of the AR function also activates the AR camera, which is, e.g., one or more front-facing cameras on a smartphone or similar device, a front-facing camera system on enabled glasses or goggles, or the like. The customer's system uses the video feed (potentially along with other sensors like GPS, compass, orientation sensors, WiFi location) to match the AR camera's viewpoint with the contextual placement information for the cached AR merchant objects. When matches are found, the AR objects are blended with the AR camera scene so as to appear in the scene in the video output shown to the customer.

The customer may choose to interact with the AR objects visible in the current scene, e.g., to “Select,” “Upload,” or “Save” an object. A “Select” function can be activated, e.g., by touching a play/pause icon on a touchscreen, where the play/pause icon is shown on or near an AR object that includes video and/or audio content. For AR objects that link to vouchers or rewards, touching the object on a touchscreen “collects” that item for the customer to allow them to use it. The customer can access a “Save” function, for instance with a longer tap on an AR object, to save the object for later review.

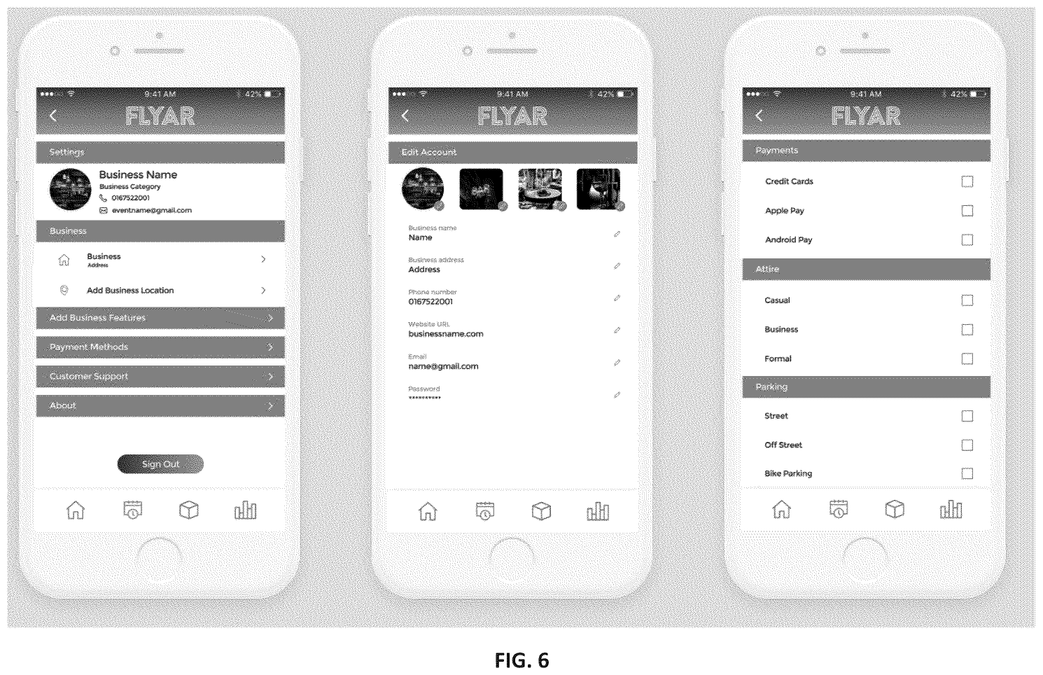

In addition to the AR functions above, apps 102 and 104 have further interfaces that will now be described. For instance, FIG. 6 shows three screens that prompt a merchant to create an initial presence in the system (with the trade name “FLYAR” in these embodiments). The left screen shows a high-level menu with options for basic business information (name, category, phone number and e-mail address), location, features of the business, payment methods accepted, customer support, and a business description (“About”). Accessing these menus allows the merchant to store, in the server system 108, business information that the system makes available to customers and/or uses to pair customers with businesses of interest.

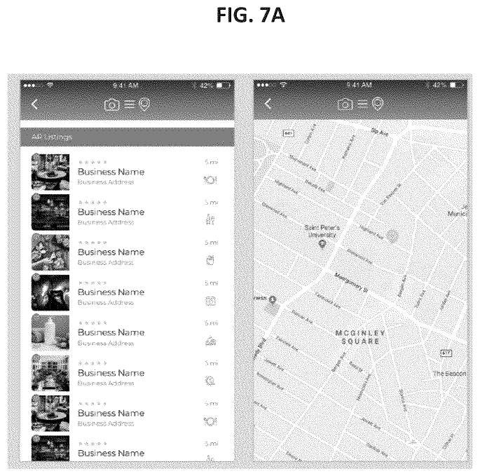

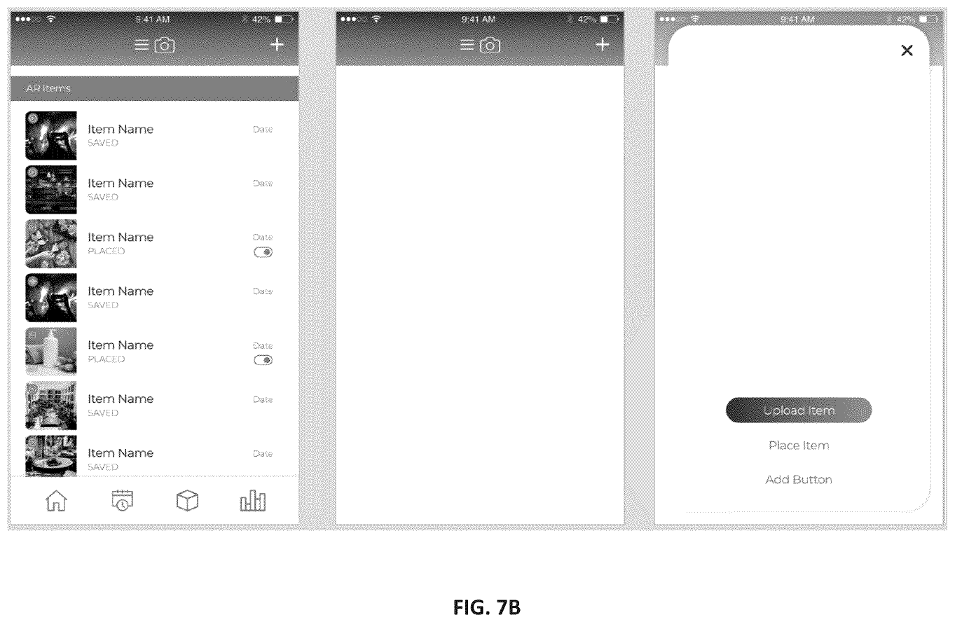

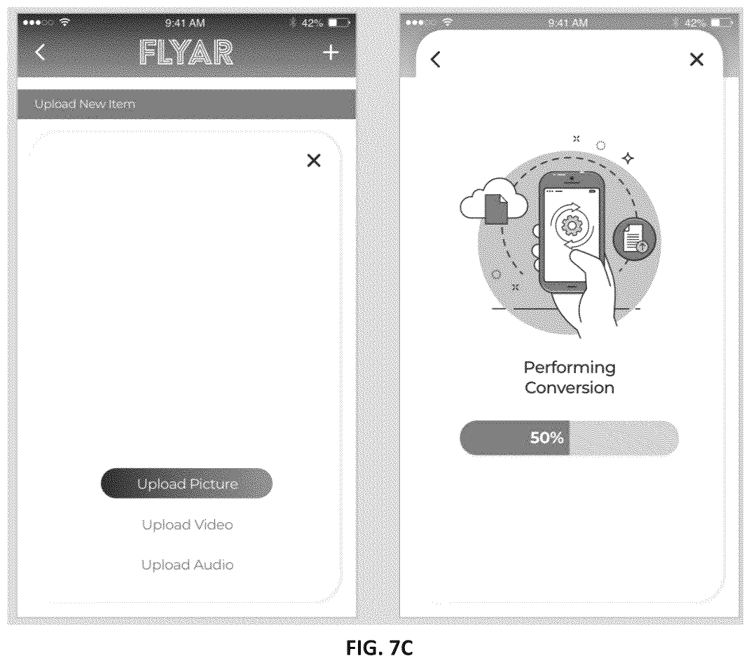

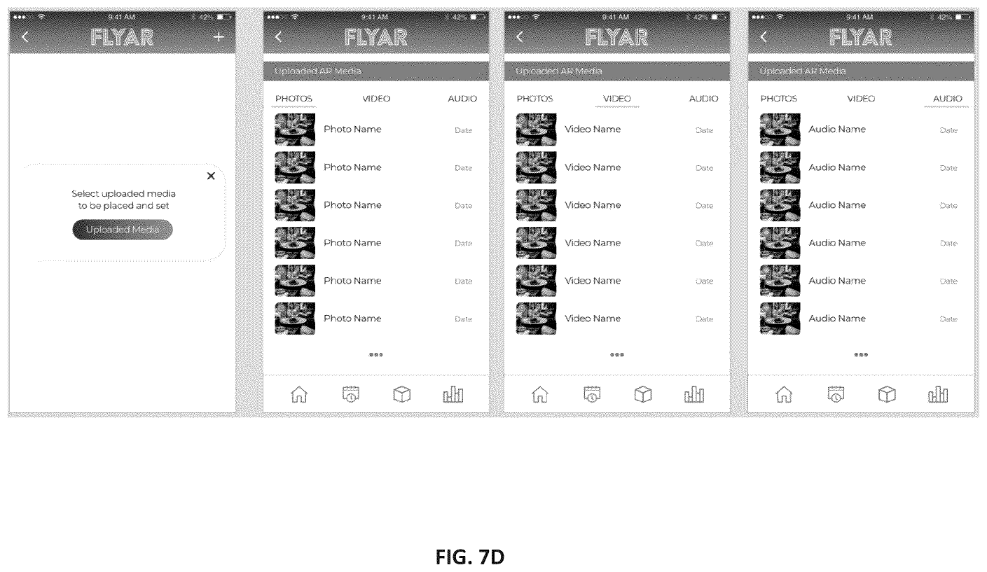

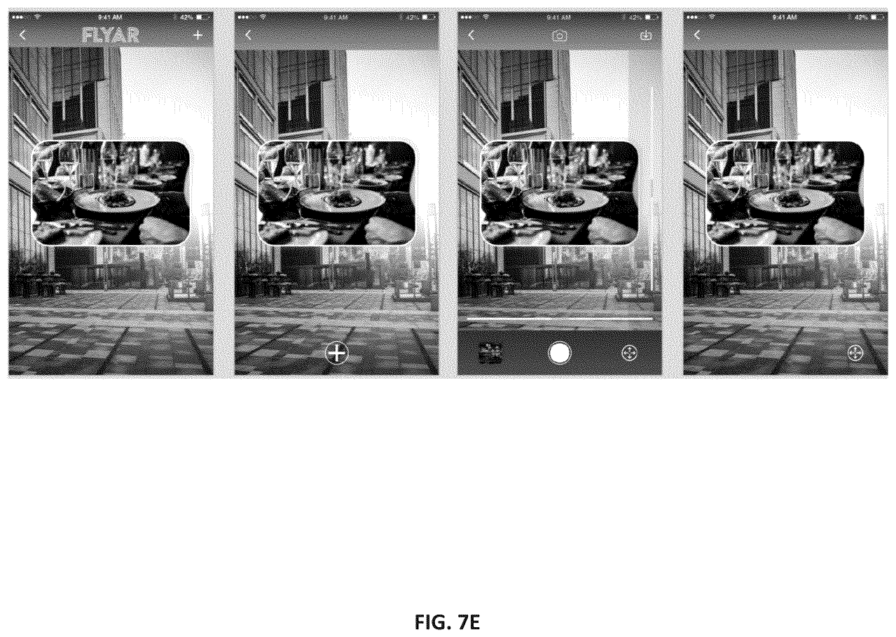

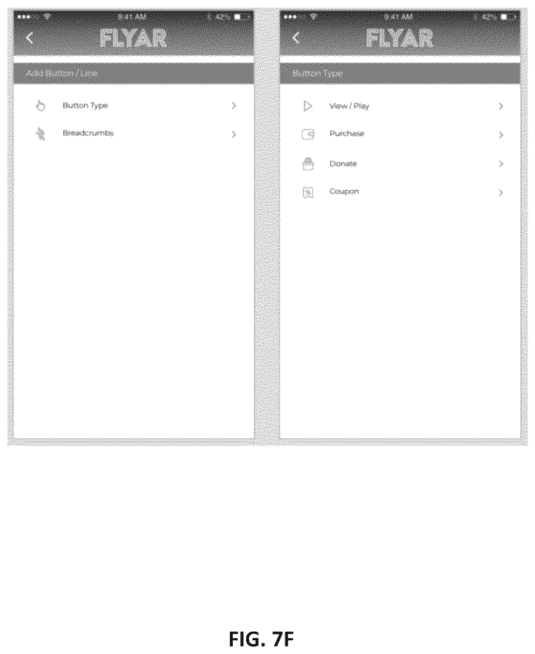

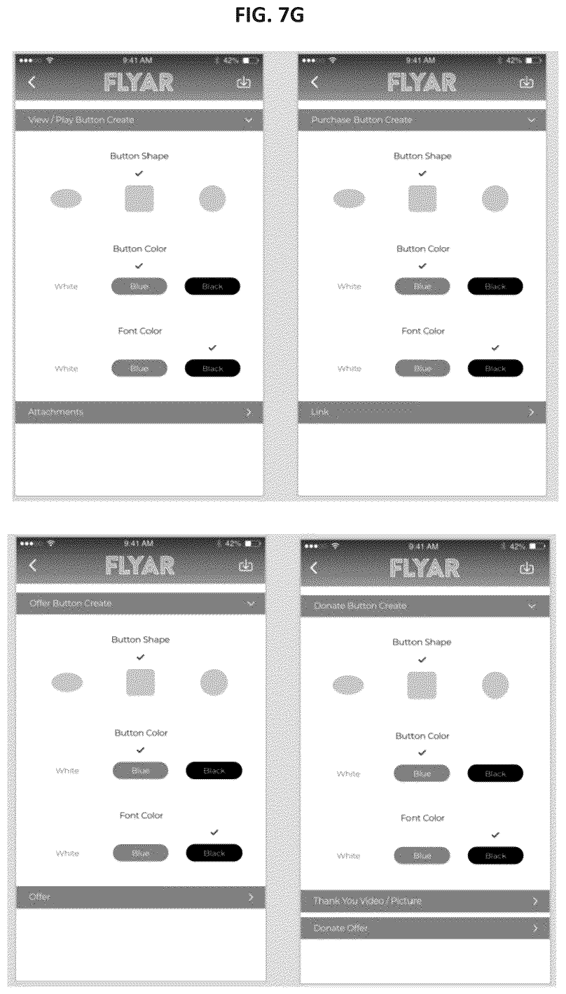

FIG. 7A shows “active” interface views that a customer can select in AR app 104, other than the AR view previously described. On the left, the user may choose a list view that ranks and displays nearby merchants for a customer. The customer may select a merchant from the list to learn more about that merchant, access their content, or navigate to that merchant. On the right, the user may choose a map view that ranks and displays nearby merchants for a customer. The customer may select a merchant visible on the map to learn more about that merchant, access their content, or navigate to that merchant.

FIG. 7B shows “active” interface views that a merchant can select in AR app 102 to review their existing AR items and status of those items. The leftmost screen shows a list of all items and whether they are currently saved and/or placed for viewing by customers. Selecting an item opens it in the center screen (no item currently selected) for editing. Editing controls shown in the right screen include controls to upload an AR item and place an AR item as previously described, and an “Add Button” control that allows various controls to be added to an object, as will be described below.

FIG. 7C shows interface functions in AR app 102 to perform upload of new AR objects. On the left screen, controls for uploading pictures, video files, and audio files allow a merchant to save a new AR item to its merchant account data 114 on AR server system 108. Once an upload is initiated, the merchant is shown the right screen while the new item is analyzed and converted to an AR item format.

FIG. 7D depicts further interface functionality of AR app 102 to allow a merchant to place uploaded AR media using AR server system 108. Upon selecting a button to view the merchant's uploaded media (left screen), the merchant is presented with lists of their uploaded AR media, sorted by photos, video, and audio, as shown respectively in the three rightmost screens, for selection and placement.

FIG. 7E illustrates AR app 102 interactive screens that assist in placement of an AR object. Once a merchant selects media, they are shown the media in their field of view. The merchant can move the object about the field of view, with the system 108 using the merchant device sensed location and orientation and scene recognition to locate the object as requested by the merchant. During the process, the merchant can toggle an AR camera view to see how a customer will see the AR object in their field of view, and then make size/position adjustments if necessary. Finally, the merchant saves the position to add the object to the system 108.

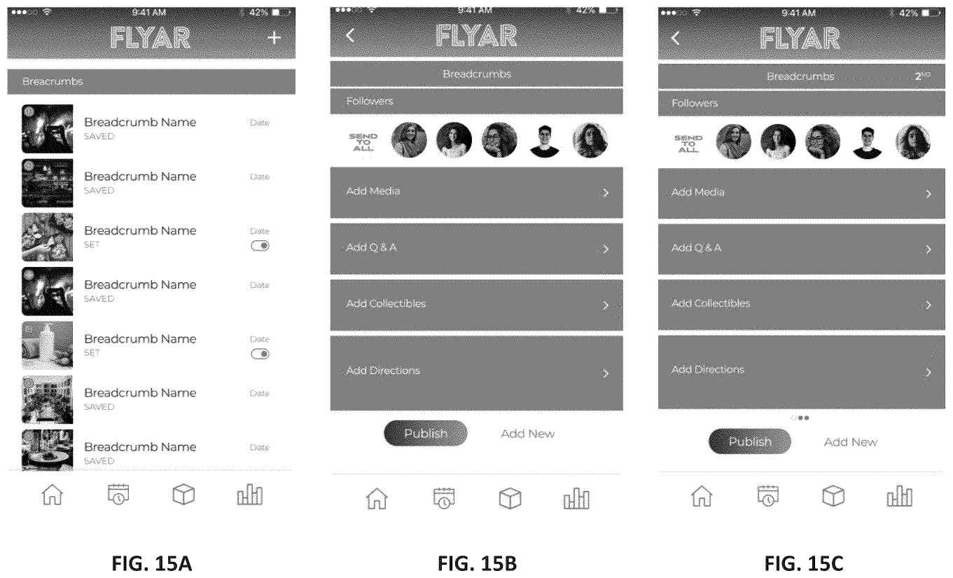

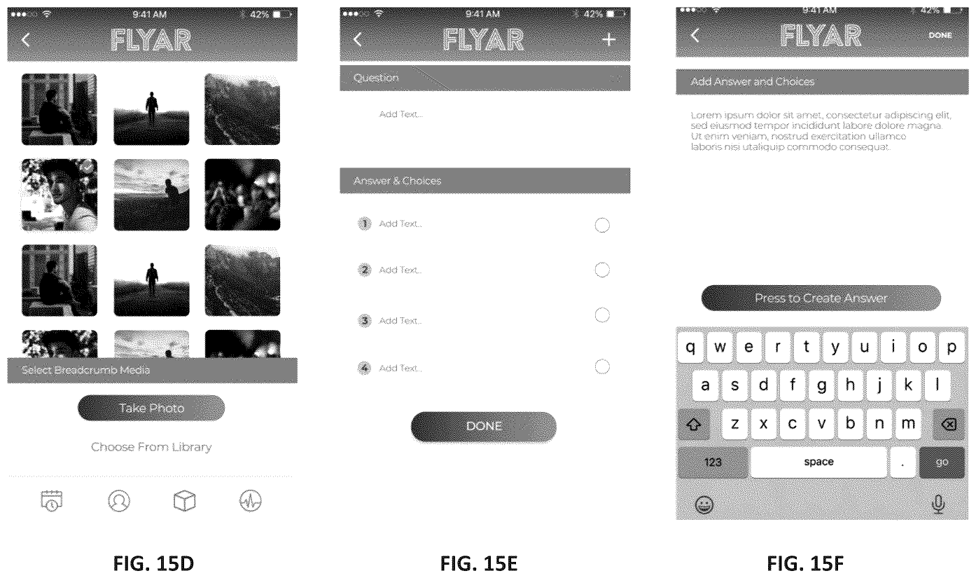

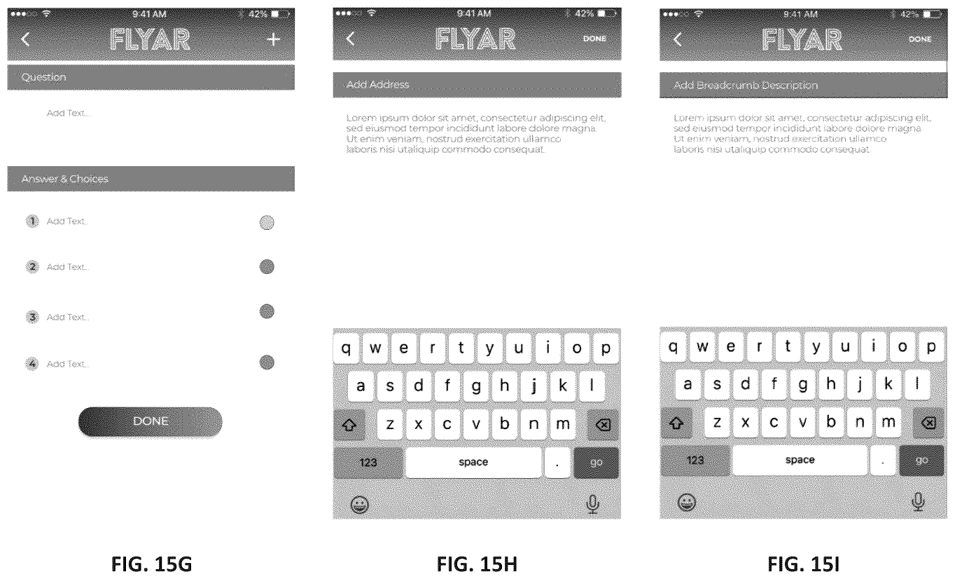

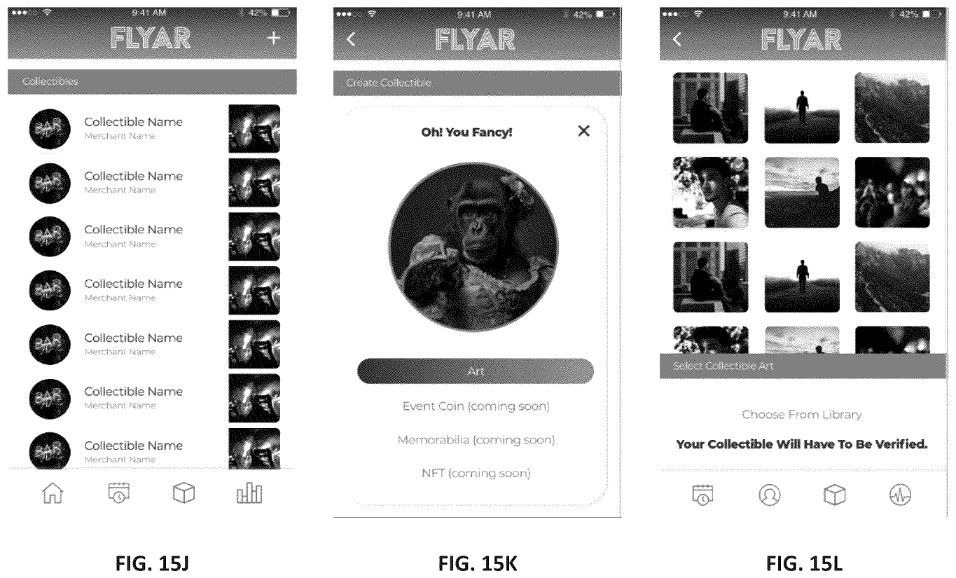

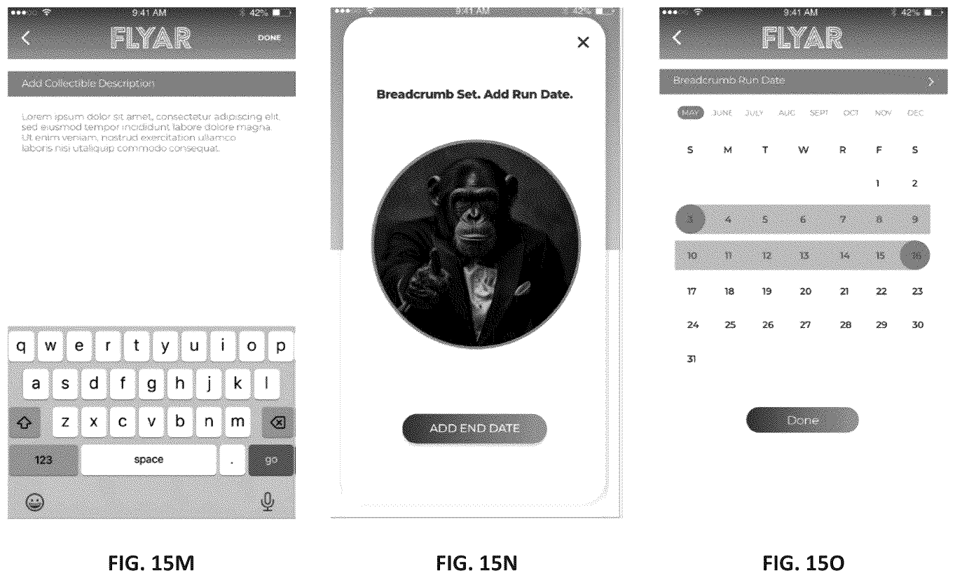

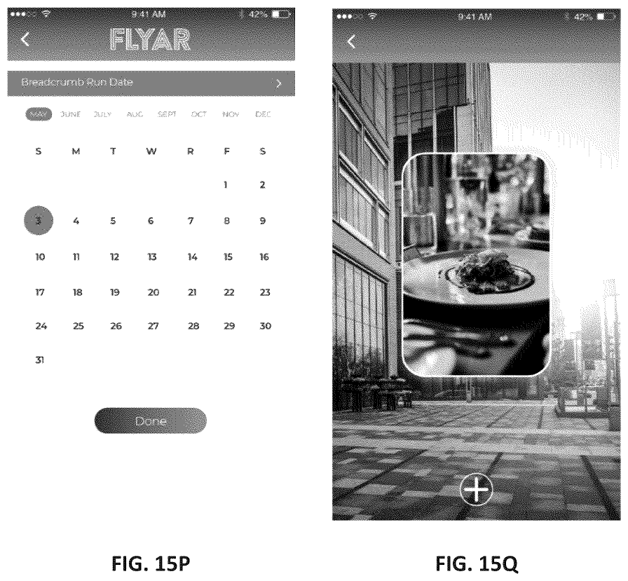

FIG. 7F illustrates interface tools in AR app 102 to allow the merchant to add buttons and breadcrumbs to an AR object during or after placement of the object. Buttons, after creation, are real-time signage that is displayed with an AR object to allow various types of customer interaction with the AR object, as defined by the merchant. For instance, a view/play button can be added to allow a customer to start/stop video or audio playback that is part of an AR object. A purchase button allows a customer to initiate a real-time purchase or order for goods, services, promotions, or events linked to the AR object (for instance, a food item that can be immediately purchased and prepared for the customer, or a ticket to a venue). A donate button allows a customer to donate to a merchant's advertised cause, associated with the AR object. And a coupon button allows a customer to gather a coupon or similar enticement to try the merchant's products or services. Breadcrumbs can also be added to an AR object. For instance, an AR object displaying a food menu item can be linked to a breadcrumb, which, as described below with reference to FIGS. 15A-Q, are generally merchant-defined “trails” of tasks in the nature of an in-application scavenger hunt that allows a customer to obtain a reward for completion.

FIG. 7G illustrates four interface tools in AR app 102 to allow the merchant to customize button function and appearance respectively for view/play buttons, purchase buttons, offer buttons, and donate buttons. The merchant uses these screens to customize button appearance and link to actions, such a purchase link, offer link, and thank you link.

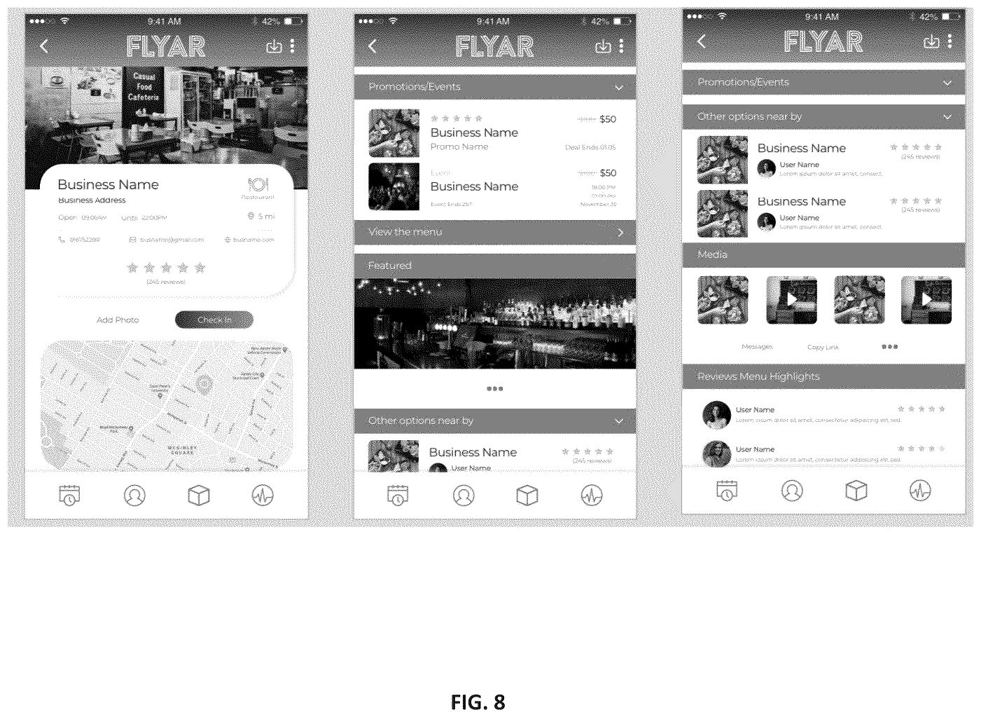

FIG. 8 illustrates screens of a merchant “home” business screen that a customer can access through the AR interface, list interface, and map interface of AR app 104. The three screens shown in FIG. 8 are all part of a same page served to AR app 104 by AR server system 108, which is scrollable to view different portions of the merchant page. The left display shows the top of the merchant business screen, which shows a merchant-uploaded photo, business info such as hours and contact information, and a map location. Prominent near the top of the merchant business screen are “Add Photo” and “Check-in” buttons, which allow a customer to add their own photos linked to the merchant or check-in at the merchant location. Such functions can have defined privacy settings, e.g., in a default setting only the merchant and friends of the customer can see the photos and check-ins added by a customer.

The middle portion of the merchant business screen, shown in the middle screen view of FIG. 8, shows current promotions and events running at that merchant, and can contain other merchant-added information such as a menu, featured images and videos, and other promotional information. Below this, the AR server system 108 can populate the merchant page with links to other nearby merchants, as ranked by ranking engine 140 based on, e.g., goods/service similarities and/or preferences of the particular customer. Below this block (right screen view), other media associated with the merchant, and uploaded either by the merchant or the customer's friend and customers they are following, are accessible. Below this block, user reviews and ratings for the merchant are ranked and served by the system 108 for viewing by the customer.

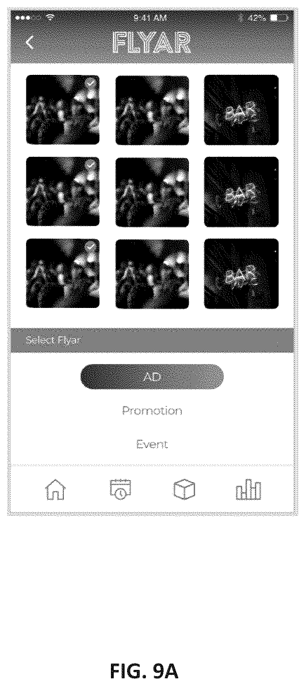

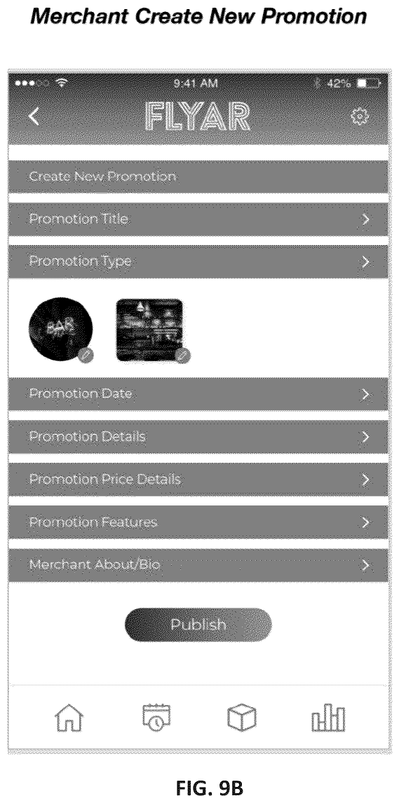

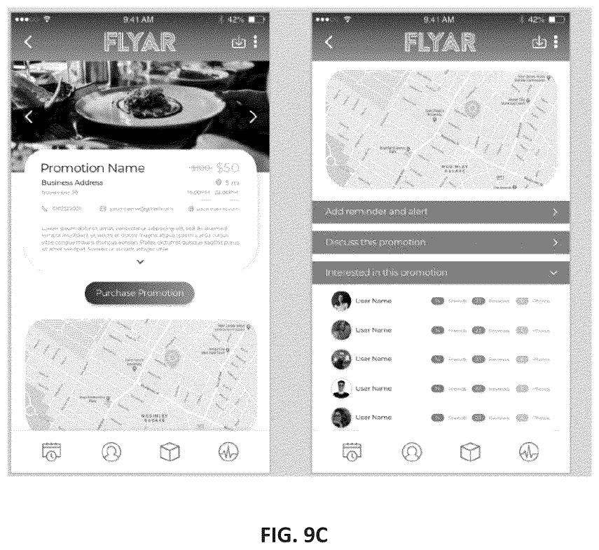

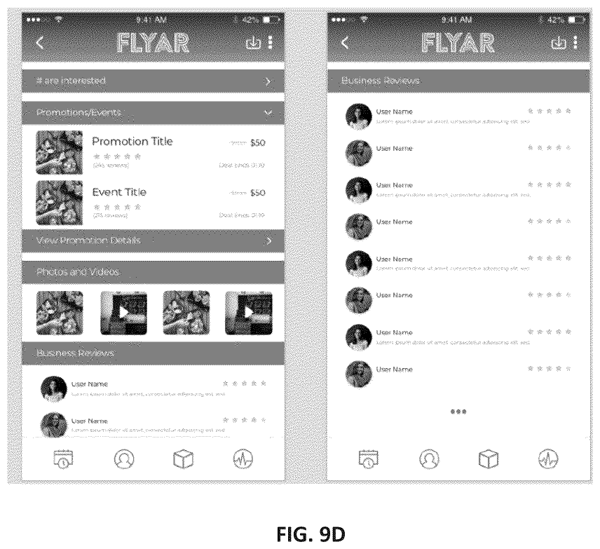

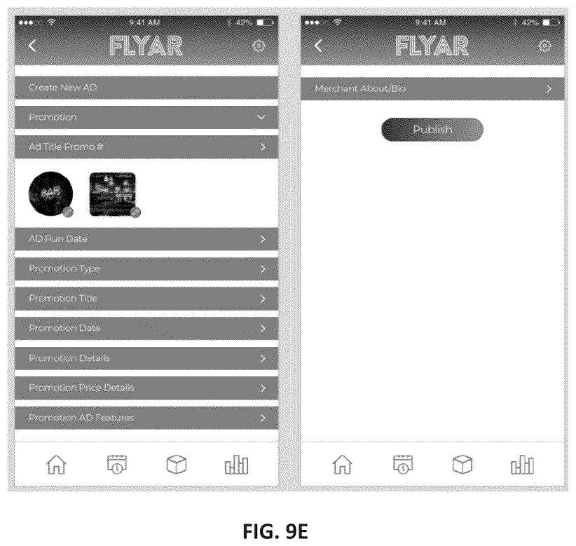

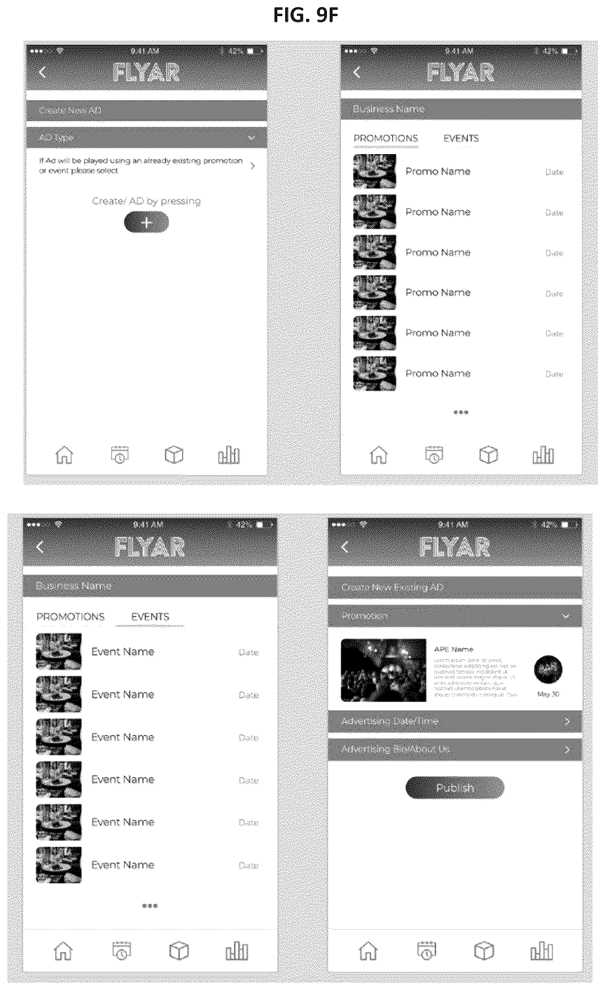

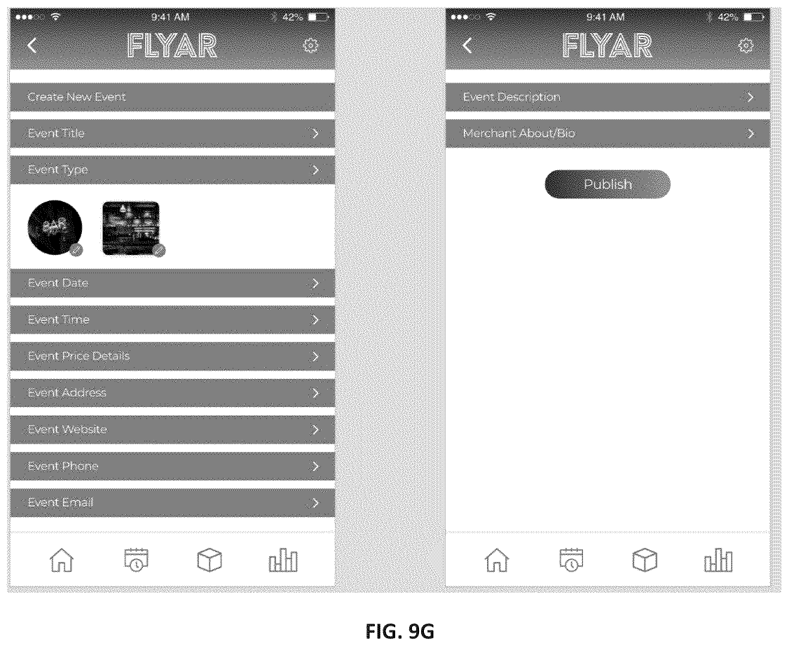

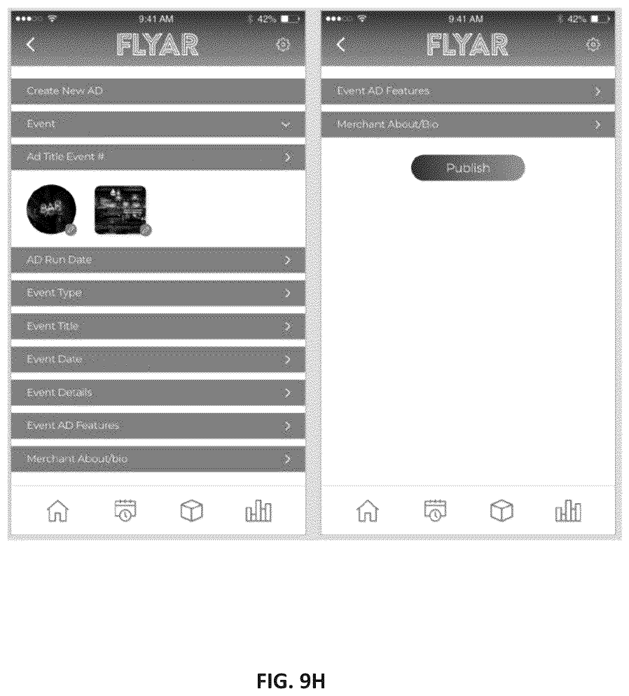

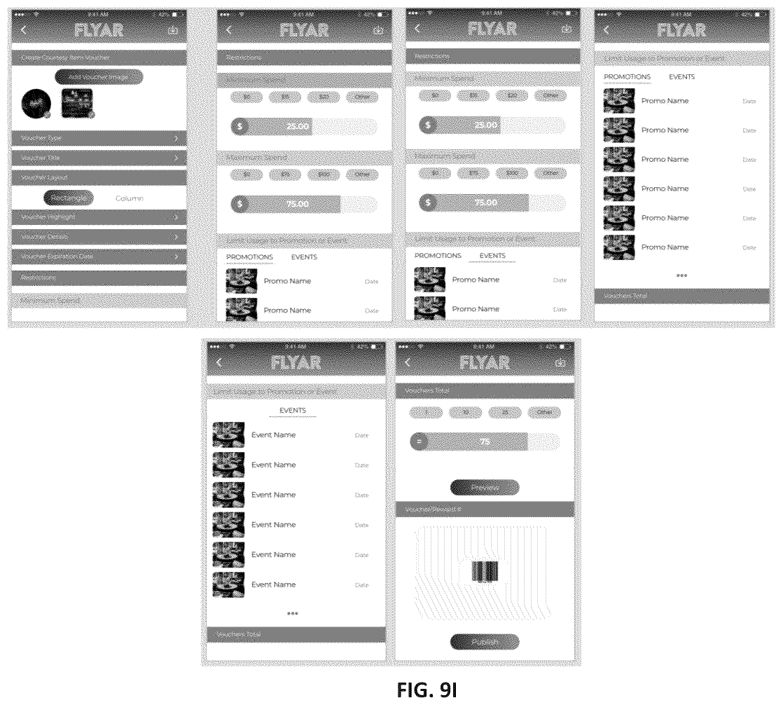

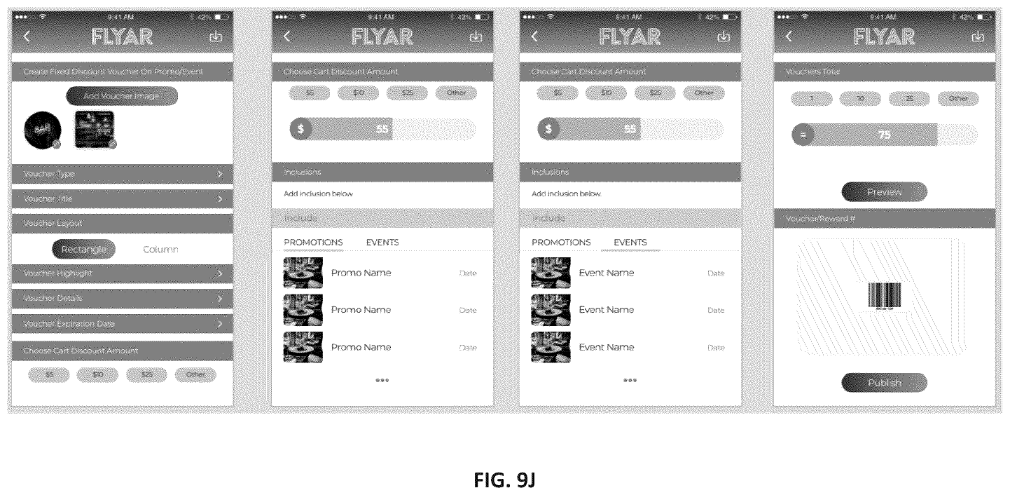

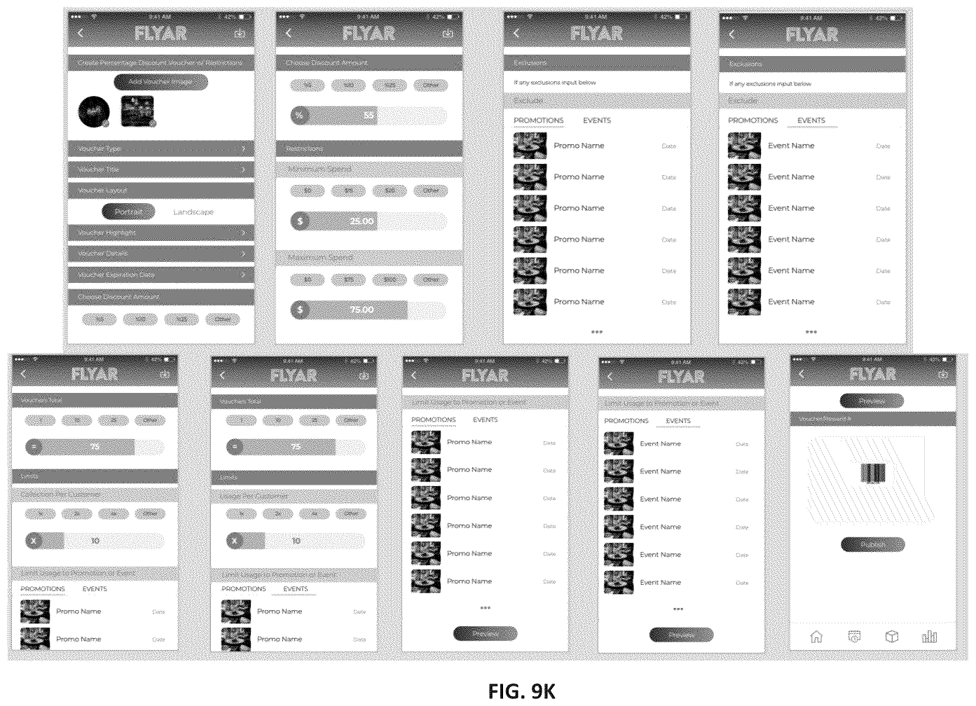

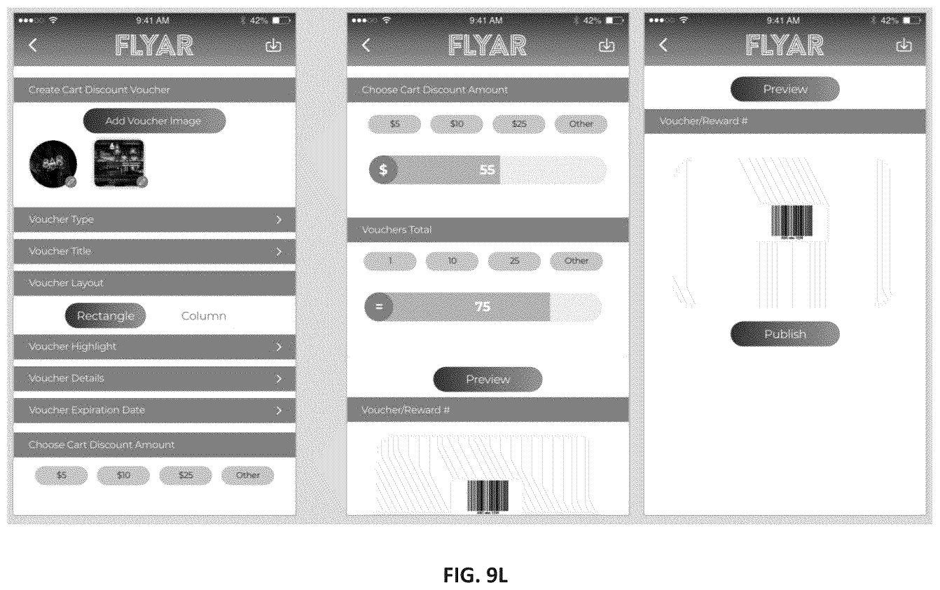

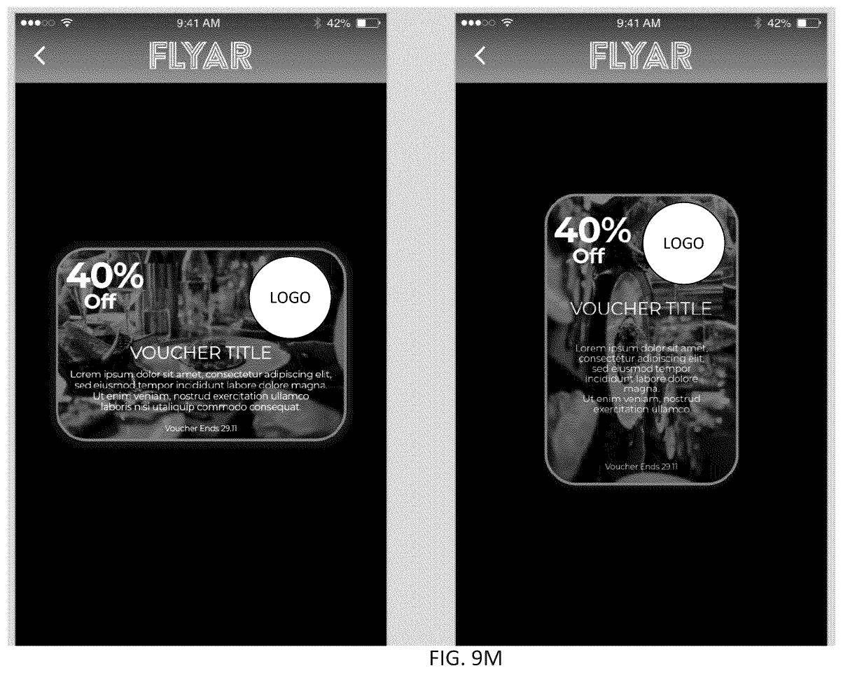

Merchant advertisements (ads), promotions, and events (“APE”) are added by a merchant to their merchant business screen through an Add APE screen interface of app 102, as shown in FIG. 9A. From this screen, the merchant selects uploaded media if desired, and then selects a button for an “AD,” “Promotion,” or “Event” to create a desired merchant item.

By selecting the “Promotion” button in FIG. 9A, the merchant is taken to a promotion creation interface as shown in FIG. 9B. This interface allows the merchant to set up one or more of a title, promotion type, date/time for the promotion to be active, details, pricing, features, and merchant information to be published with the promotion. Once the desired parameters have been entered, the merchant selects “Publish” in the interface to cause AR server system 108 to save the promotion to database 110. Depending on what is set in the date field, the promotion can go “live” immediately, or at a time/date specified by the merchant.

FIGS. 9C and 9D illustrate an interface appearance with two scrollable sections for a merchant promotion screen, as seen by a customer accessing that promotion through customer AR app 104. At the top of the merchant promotion interface, the promotion/details are displayed above a purchase promotion button that allows the customer to immediately take advantage of the promotion. The customer is also offered a map to the merchant, an ability to set a reminder to access the promotion later, a button to discuss/share the promotion with friends, and a list of friends or public influencers interested in the promotion. The discussion and list allow a customer to easily collaborate with others to jointly select the promotion. Below the list of particular people interested in the promotion, a total number of interested users (which includes interest that is private as to this particular customer is visible), followed by other merchant promotions and events, further promotion details, and general merchants' information such as media and business reviews that are also accessible through the merchant business screen.

FIGS. 9E and 9F show interface functions of merchant AR app 102 used to create new ads. Initial fields for ad creation are similar to promotion creation, as shown in FIG. 9E. FIG. 9F illustrates the ability for the merchant to use the interface to link an ad to an existing promotion or event, e.g., to advertise that promotion or event. Ads may also advertise any other goods or services of the merchant, separate from a promotion or event.

FIG. 9G shows interface functions of merchant AR app 102 used to create new events. Initial fields for event creation are similar to promotion creation, as shown in FIG. 9E. As shown in FIG. 9H, at the time of event creation, the merchant is also given an interface to create both an event and an ad for the event at the same time.

FIG. 9I shows interface functions of merchant AR app 102 used to create new vouchers. Initial fields for event creation are similar to promotion creation, as shown in FIG. 9E. Although a voucher could have broad applicability to a merchant's goods and services, the system 108 allows the merchant to create various restrictions on a voucher (minimum/maximum spend, applicable promotions/events, maximum number of vouchers issued). As shown in the last display of FIG. 9I, the system 108 will also generate a bar code (or QR code, alphanumeric code, etc.) at the time of publication that a customer can use to redeem the voucher.

As shown in the interface functions of merchant AR app 102 shown in FIG. 9J, one voucher type a merchant can create in the system is a fixed voucher (fixed discount amount) to be applied to a promotion or event.

Another voucher type that can be created by a merchant, as shown in FIG. 9K, is a percent discount voucher. The voucher can be set with excluded events/promotions, applicable events/promotions, limits on total vouchers, and limits on uses by a same customer, as shown in the interface displays of FIG. 9K.

Another voucher type that can be created in the system 108 is a cart discount voucher, as shown in FIG. 9L. The cart discount voucher, instead of applying to a single item, applies to a collection of items purchased by a consumer.

FIG. 9M shows sample landscape and portrait vouchers automatically created by AR server system 108 based on a merchant's input to include the voucher title, merchant logo and background photo, voucher amount, restrictions, and expiration date. The system 108 can either build the voucher and save it in the system database 110, or save the elements of the voucher for creation in real-time when accessed by a customer.

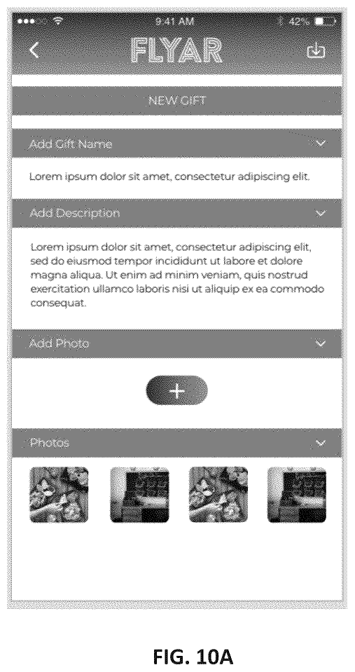

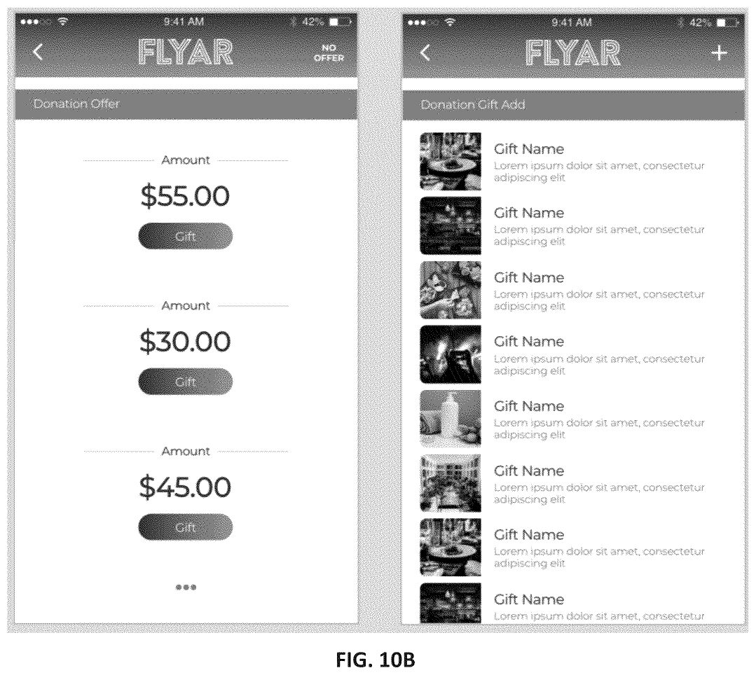

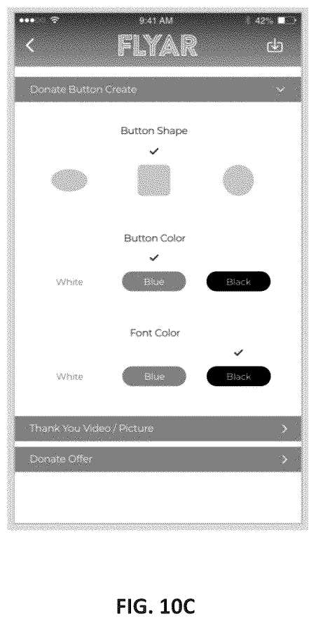

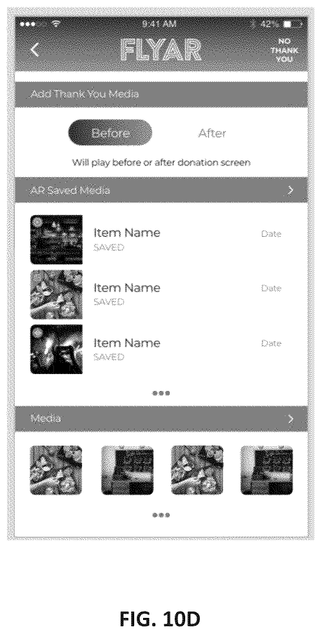

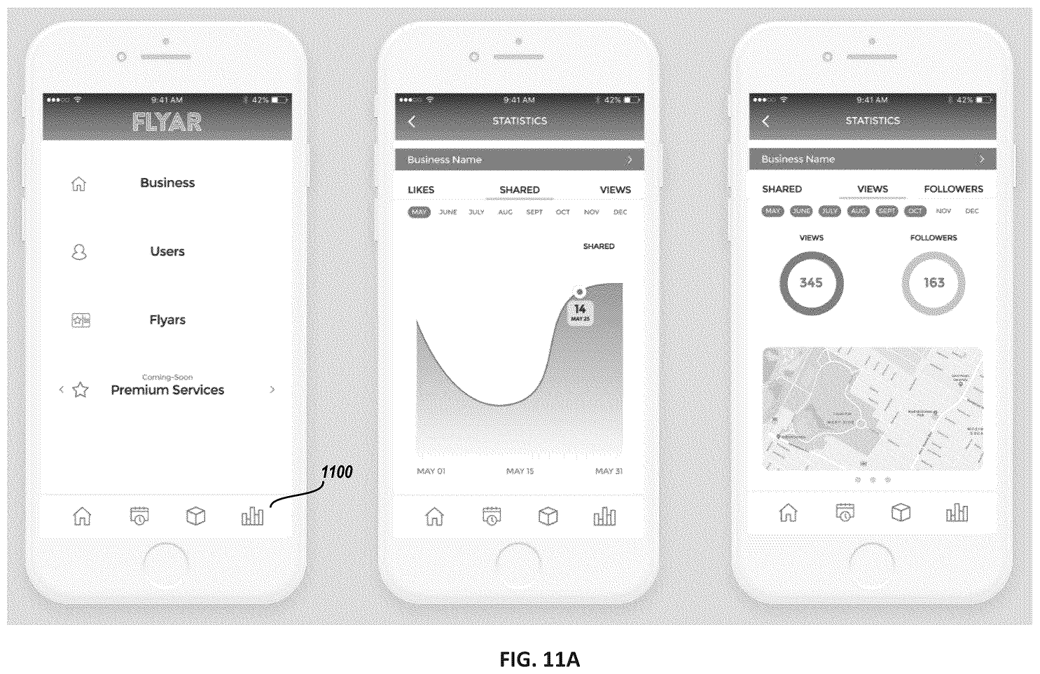

FIGS. 10A-10D illustrate functionality accessible through the merchant AR app 102 for creation of gifts and donations. FIG. 10A shows the root interface for a new gift, where the merchant adds a name, description, and photo (or other media) linked to the gift. FIG. 10B shows the interface for selecting a donation amount, and adding the gift to a list of active gifts in the system 108. FIG. 10C shows the interface for selecting a donation button appearance, and adding either a thank you message/video for those that donate and/or a gift for those that donate. FIG. 10D shows the interface for deciding whether thank you messaging plays before or after a donation screen, and for either selecting media stored on AR server system 108 or stored/accessible by the merchant's device running AR app 102.

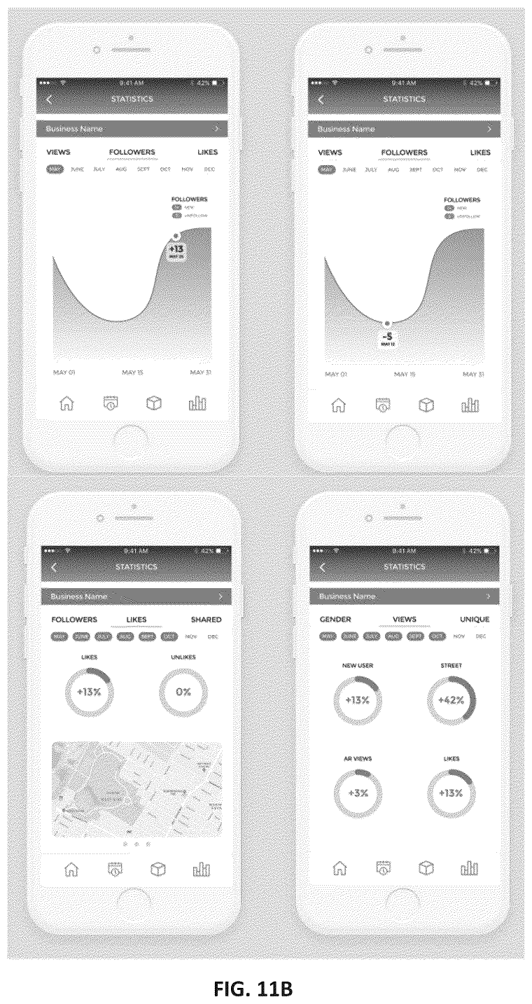

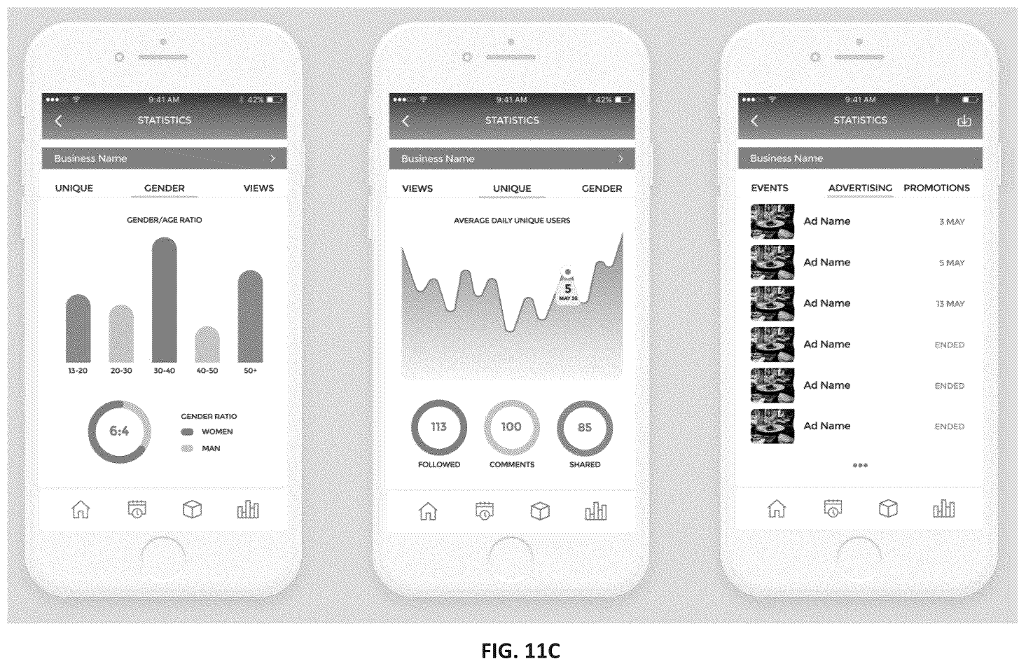

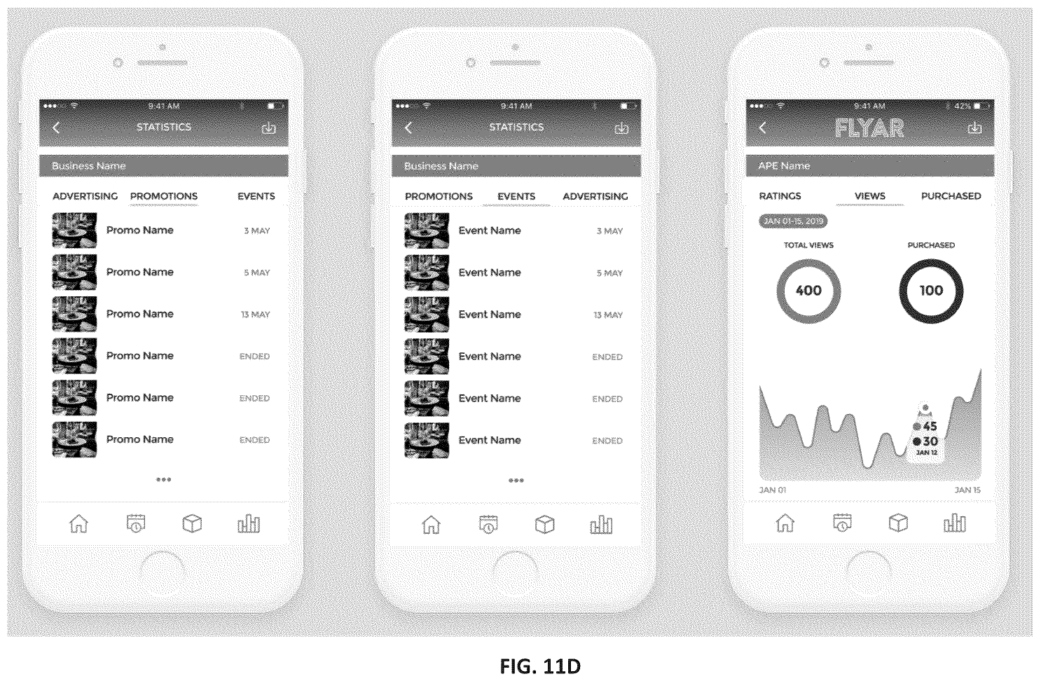

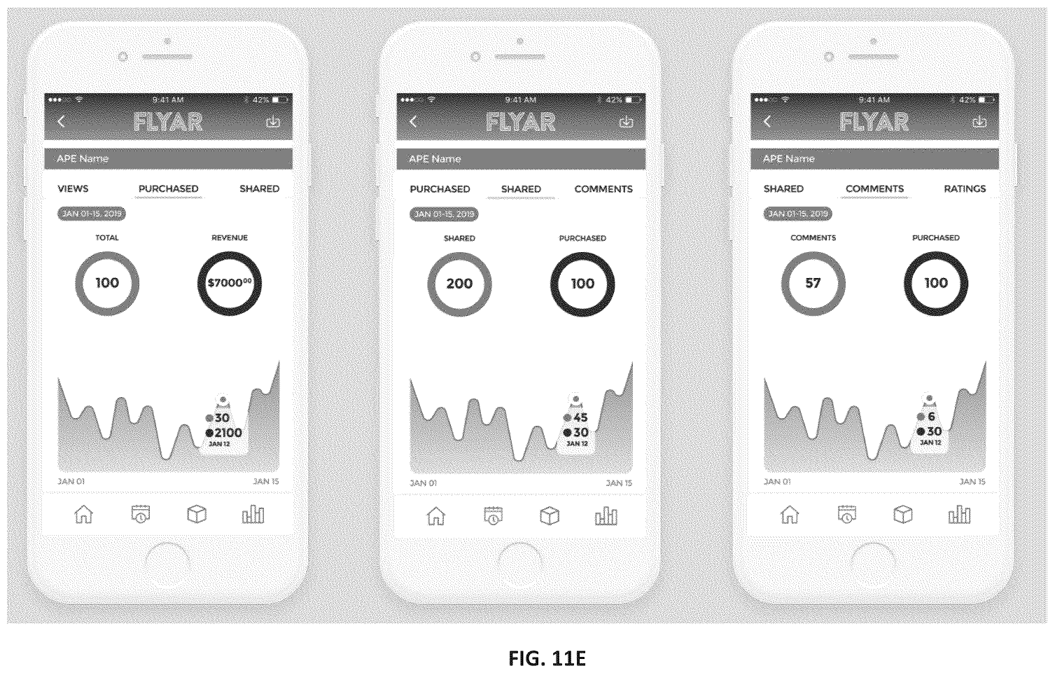

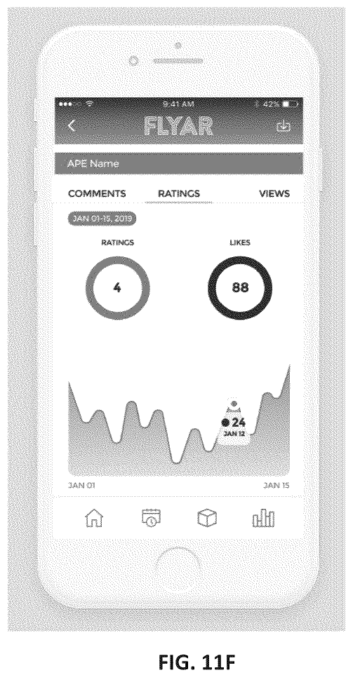

As shown in FIGS. 11A-11F, each merchant has accessibility through the merchant/AR app 102 to AR system statistics relevant to their business, by accessing an icon 1100 on the merchant home page (FIG. 11A, left panel). A variety of statistics can be gathered by AR server system 108 and served to a merchant's device. For instance, in the central panel of FIG. 11A, top-level business engagement in the form of likes, shares, views, and followers can be accessed on a monthly and daily historical basis and displayed in chart form to the merchant. And as shown in the right panel of FIG. 11A, business engagement statistics can also be mapped to a geographical map to indicate the location of users at the time they engaged with the business. And as shown in the first three panels of FIG. 11B, statistics can show percent change in interaction rather than absolute numbers. The fourth panel of FIG. 11B illustrates a further breakdown of a given statistic (views in this case) into subcategories that a merchant may also want to understand in order to gauge the effectiveness of their campaigns. These subcategories can include those shown (by gender, unique viewers, new users of the merchant, views from the merchant's street, AR views, and views that resulted in likes) or other subcategories derivable from data tracked by AR server system 108.

FIG. 11C shows further subcategory displays accessible by the merchant. In the left panel of FIG. 11C, views are graphed by both age range of the viewer and gender of the viewer. In the center panel of FIG. 11C, average daily unique users are graphed over time, and paired with statistics on how many of those users followed, commented on, and/or shared information about the business. In the right panel of FIG. 11C and the left and center panels of FIG. 11D, the merchant is presented lists of current/past ads, promotions, and events, respectively, in order to select them and view statistics specific to that item.

In the right panel of FIG. 11D, as well as FIGS. 11E and 11F, the merchant has selected a particular promotion to see promotion-specific statistics. As illustrated in FIG. 11D, the merchant has requested to see views over a two-week period for a particular APE, and has been served a views-vs-time graph for the two-week period, as well as total views and purchases for the APE over that time period. The merchant may drill down to day-specific statistics or scroll to other date ranges from this view.

In the left panel of FIG. 11E, the merchant has requested purchase statistics for the APE item, and sees both total purchases and revenue derived from those purchases in the graphic.

In the center panel of FIG. 11E, the merchant has requested shared statistics, and sees both how many times the APE item was shared and purchased over the time range.

In the right panel of FIG. 11E, the merchant has requested comment statistics, and sees both how many comments the APE item received over the time range and how many times it was purchased.

In FIG. 11F, the merchant has requested rating statistics for the APE item, and sees the number of ratings and likes the APE item has received over time.

As can be appreciated from the foregoing description, the ties between the merchant app 102, the customer app 104, and the AR server system 108 create powerful tools for merchants to reach and gain interest from potential customers, as well as evaluate which APE items were most effective, and in what ways, in reaching customers.

Various interface functionalities of customer AR app 104 will now be described. Although the appearance of the interface is shown in a familiar smartphone layout, it will be apparent to those skilled in the art that the interface can be adapted to non-touch-screen computer displays, other touchscreen formats, and other devices such as VR systems.

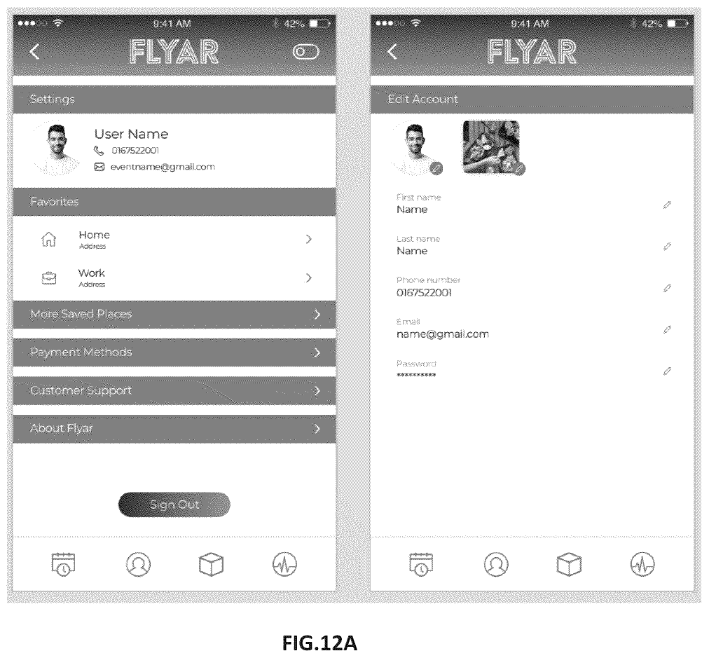

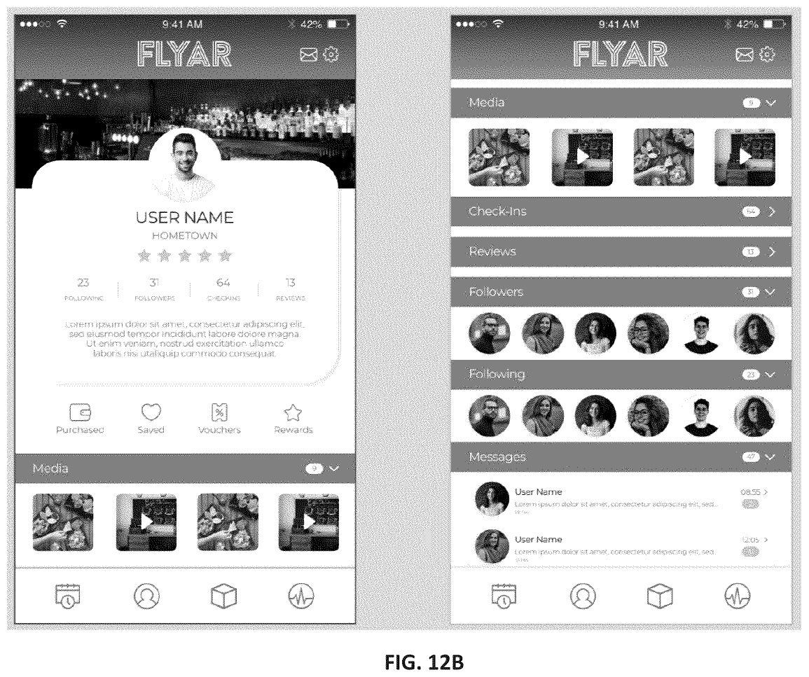

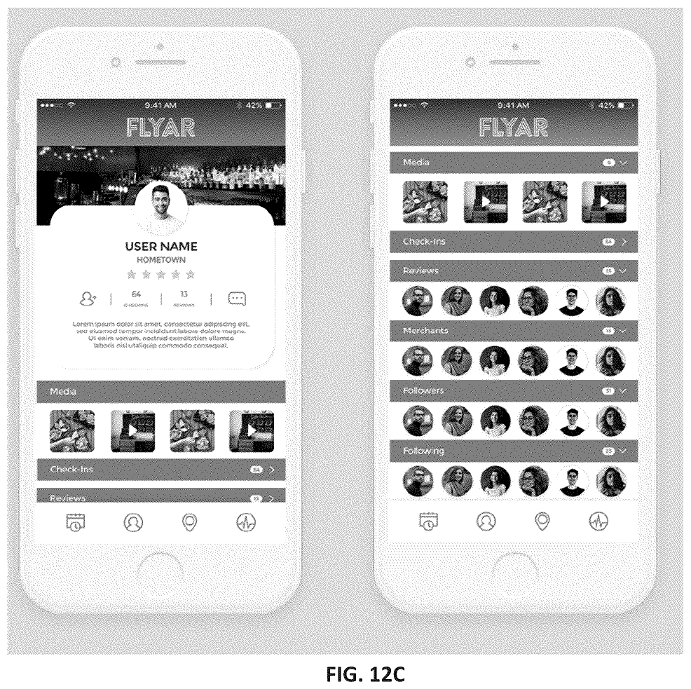

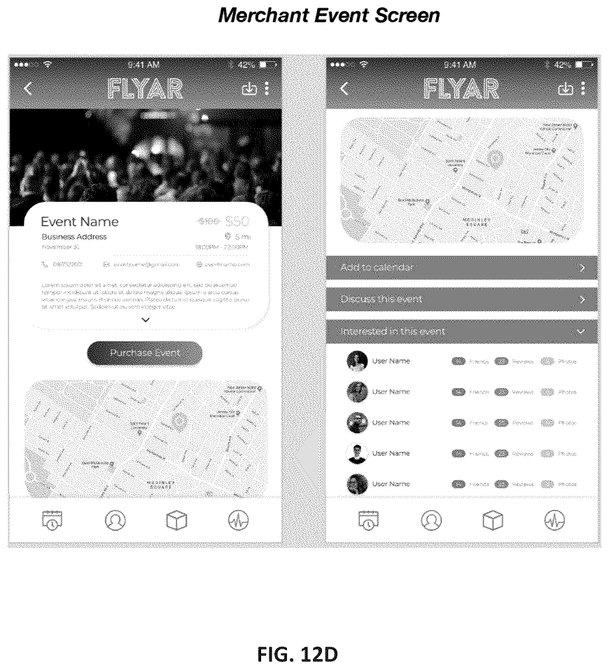

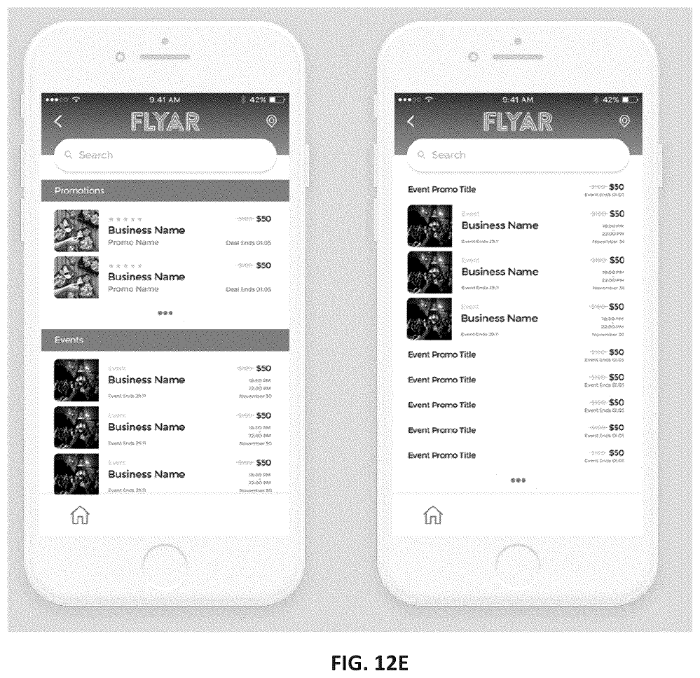

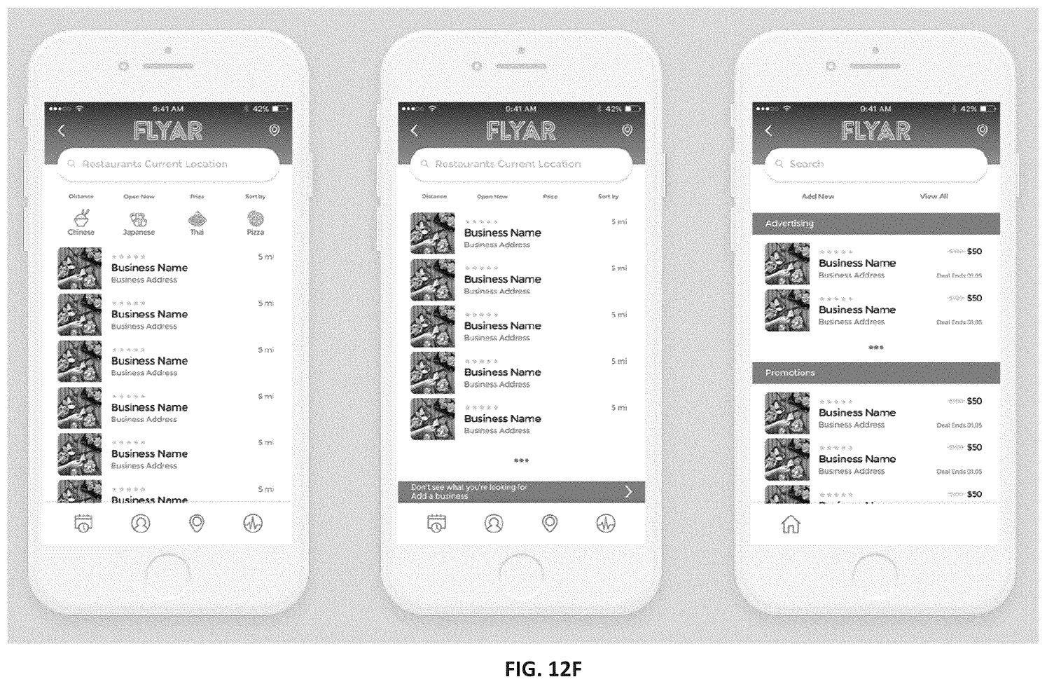

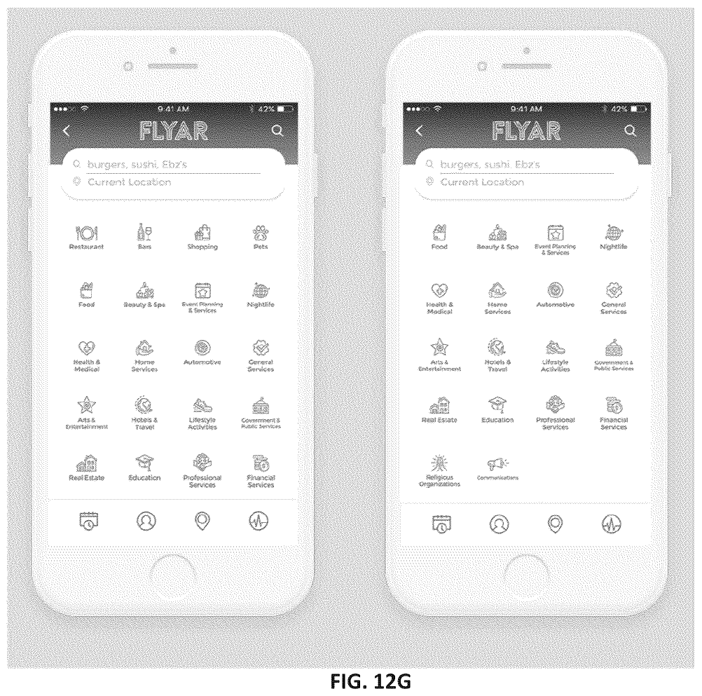

FIG. 12A shows two interface panels of a user profile setting screen. The left panel is a customer account settings home page from which a customer populates and customizes their account. It includes basic information (name, phone number, email address, password), physical addresses (home, work, and others that can help the system understand vicinities that the customer frequents), payment methods, customer support links, and information about the application. The right panel shows edit controls for basic information; editing of other settings uses similar interfaces.

As a user interacts with the AR system 108 via AR app 104, the system 108 is able to populate their account with customized information based on the user's preferences and those of similarly situated users. FIG. 12B shows a typical top portion of a user's scrollable profile screen for a user that has interacted with the system 108 for some time. The banner area shows the user's handle and profile picture, user rating, statistics (numbers following, followed by, check-ins, and review) and user-generated description. Below this are quick links to items purchased by the user, saved by the user, vouchers, and rewards available to the user. Below this, the user may access media that they have saved up to the system 108, see their past check-ins and reviews, see their follows and those they are following, and see messages from other users. Although some of this information may be cached on the user's device, all of it is generally stored/generated on the AR server system 108 and transmitted to a user's device when logged on. Information may be updated in real-time, near-real-time, or periodically, either when the user is interacting with the system 108 or in a background mode.

FIG. 12C shows a similar interface as FIG. 12B, except in this case the user has saved favorite merchants, and the profile screen contains an access row for their saved merchants.

The user can interact with the system 108 in any of the ways previously described, including via the AR tool, the map, the lists of nearby merchants of interest, saved merchants, or APE data served to the user. In FIG. 12D, the user has been notified through the interface of a nearby live event of potential interest. FIG. 12D supplies details of that event and allows the user to purchase, save, or socialize the event, as described previously.

FIG. 12E shows a user's interface display for browsing active promotions and events of potential interest. Ranked lists of promotions and events can be generated by AR server system 108 based on one or more parameters such as user location, user preferences, saved merchants, merchant paid placement, and user search parameters entered in a search bar.

FIG. 12F, left and center panels, shows a user's interface display for a preset search term, “Restaurants Current Location.” In addition to a list of nearby restaurants, the interface populates with buttons for particular filters relevant to the search, such as particular cuisines, distance, open now, price, and “sort by” for other less common search parameters, which cause the AR server system 108 to re-rank and reserve a list to the user.

Upon selecting a merchant from the list, the user may be served a display such as shown in the right panel of FIG. 12F, highlighting advertising and promotions for that particular business.

Other preset search terms can also be included in a top-level scrollable search menu on the user interface, as shown in FIG. 12G, showing different merchant/service types of potential interest. This list may be static for all users of the app 104, but preferably is one or more of customizable by the user to remove, add, and rearrange categories of merchants, and/or dynamically updated by the AR server system 108 based on how the user uses or is predicted to want to use the system 108.

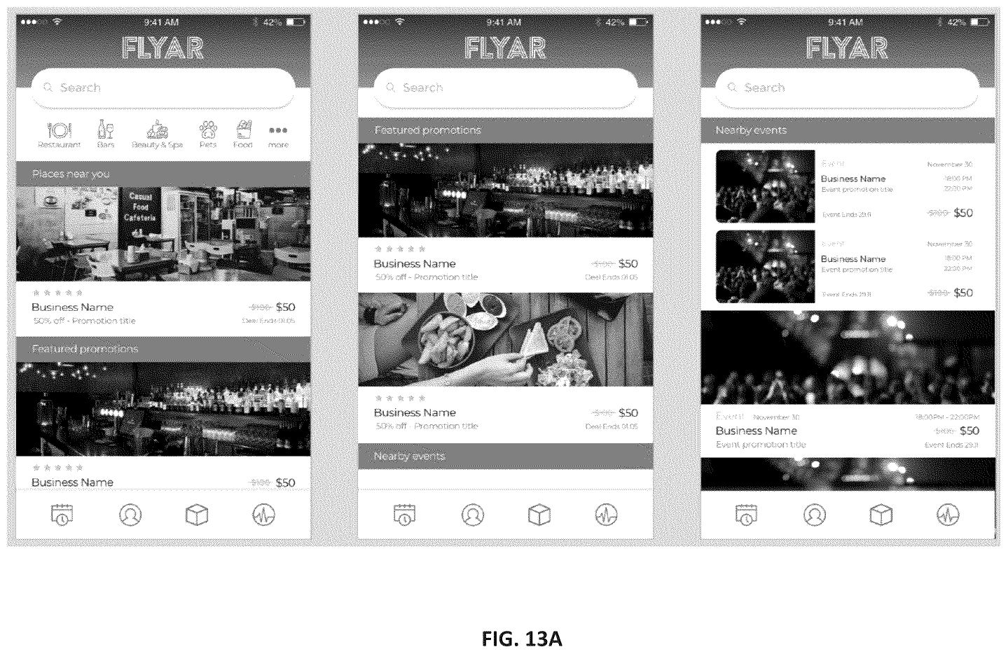

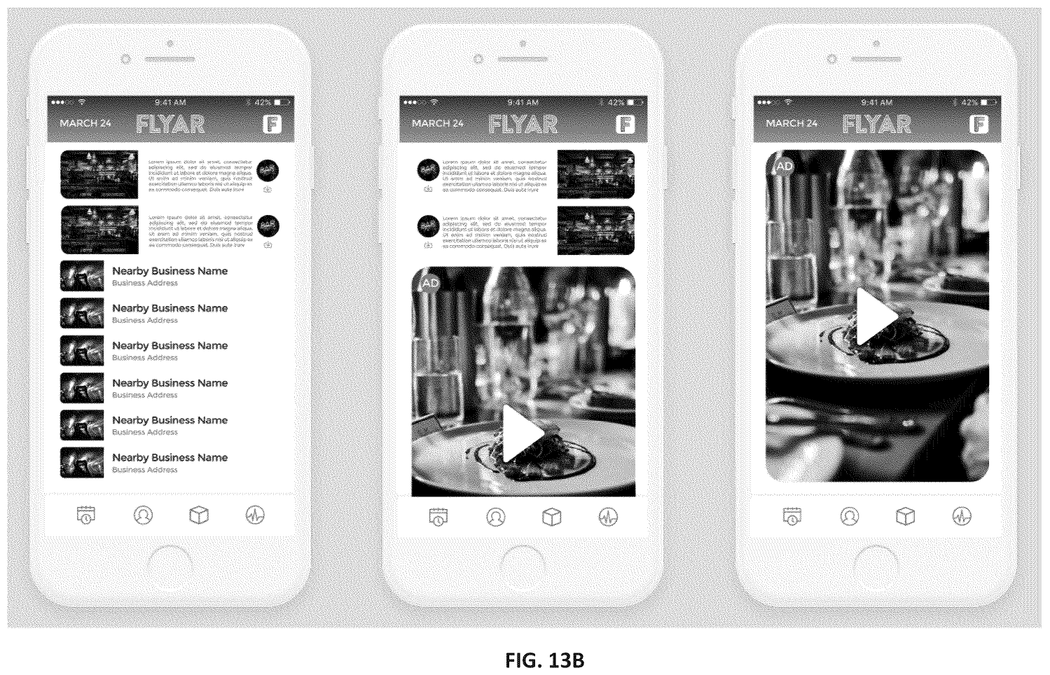

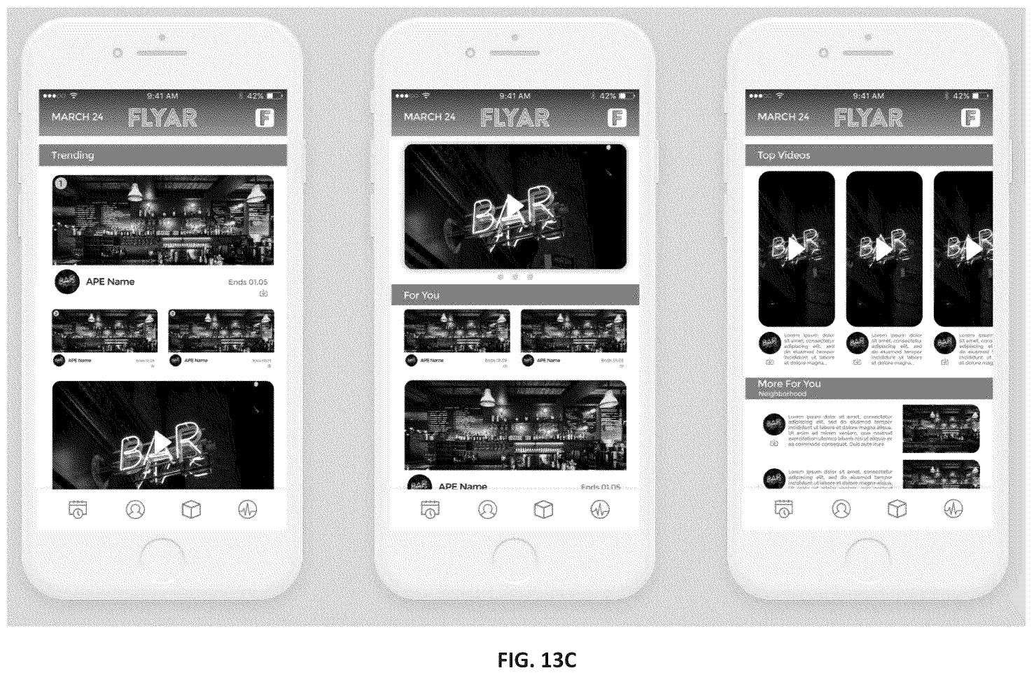

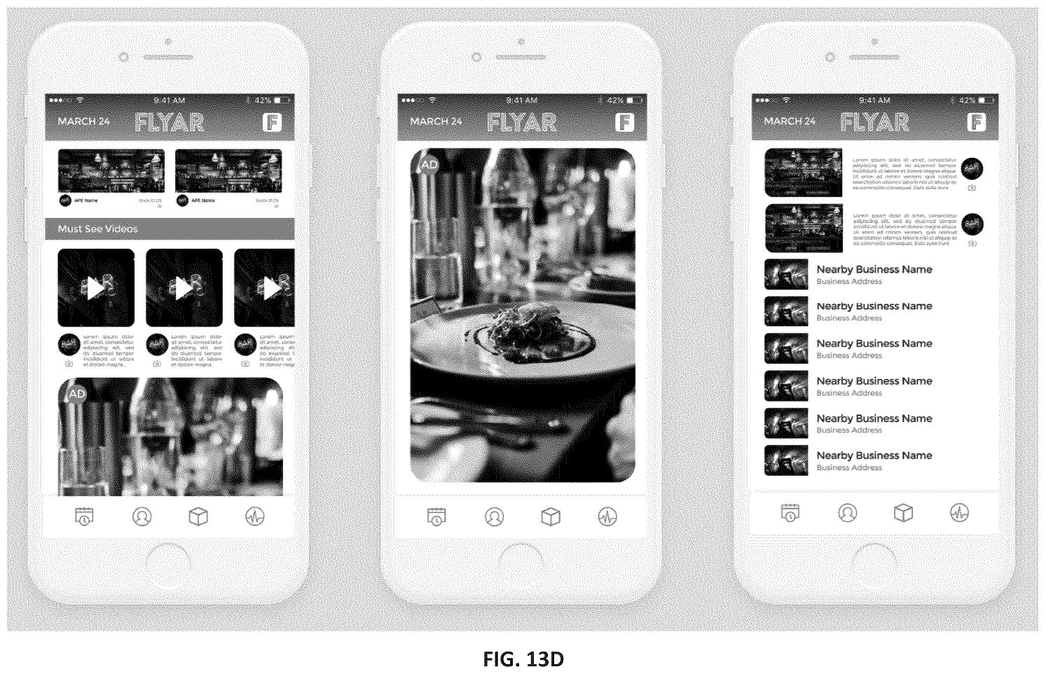

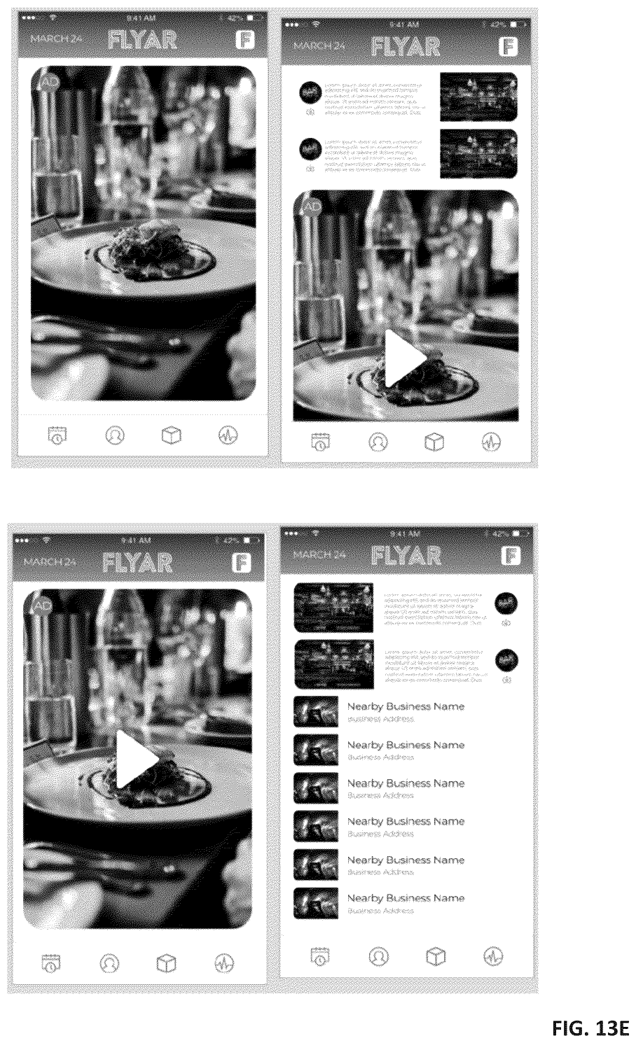

Another way that a customer may choose to use the app 104 is by accessing a “Customer Nearby” function, as illustrated in FIG. 13A. Activating this function alerts the system 108 that the user is actively contemplating a merchant visit based on their current location. The user is shown merchants in the immediate vicinity, featured events, and featured promotions. The user may also limit the merchants to a particular merchant type if the user knows what they are looking for (restaurant, bar, beauty & spa, pets, food, etc.). Merchants may use their settings to compete for placement, and can base how much they compete based on a particular user demographic (age, gender, new customer, frequent/power user, frequently nearby, etc.)

FIG. 13B illustrates yet another potential view of a “feed,” where the user may browse businesses, events, promotions, and ads, and select any of interest. Such a list can be served based on user known preferences and correlation to similar users, the user's followers, and those the user is following, as well as merchant paid placement.

The feed of FIG. 13B may be further curated into browsing categories, as shown in the interface view of FIGS. 13C/13D. In FIGS. 13C/13D, items are curated by “Trending,” “For You,” “Top Videos” (or other items), “More For You” with particular themes, such as focused on a particular neighborhood, as shown, and “Must See Videos” (or other items), at the top of the general feed of FIG. 13B.

Another interface of the system 108 is shown in FIG. 13E. This could be called a “Classified Screen.” It profiles interesting/featured merchants, shows their video blogs, and top ads. A customer may visit this page to learn more about what is new, rising in popularity, or garnering interest by the community.

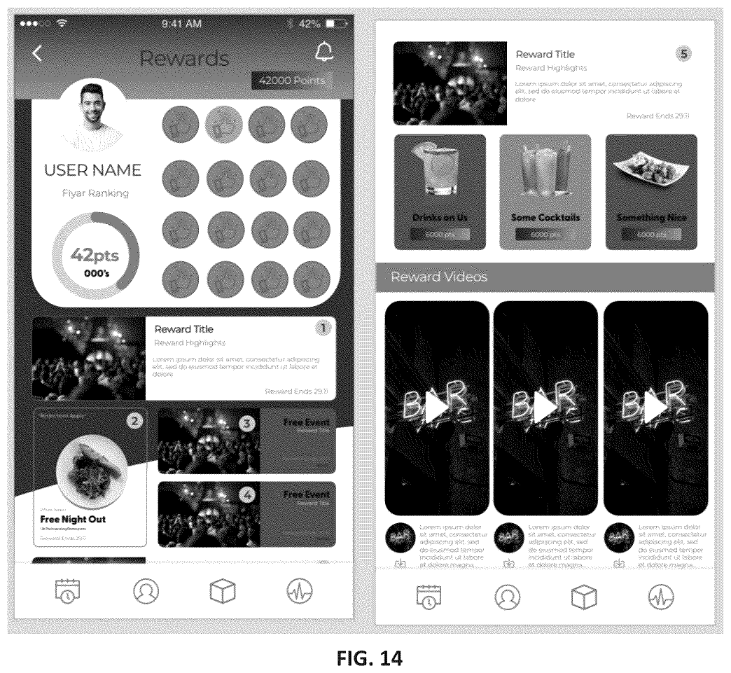

To encourage customer use of the system 108, each user has a “reward” page, e.g., as shown in FIG. 14, that encourages them to use the system 108 and interact with other users. In one embodiment, the user collects points for using the system 108 to find merchants, interact with merchant AR and APE items, write reviews, and build community, as well as passing anniversaries on the system 108. Use of the system 108 to purchase promotions, donations, etc., can result in larger point accumulation, e.g., proportional to the purchased amount. The user may use points to redeem rewards at participating merchants. The user may also receive loyalty rewards that do not require redemption of points, as illustrated.

Any of the previously described items (AR placements, ads, promotions, events, etc.), as well as other items such as “quiz” type items, can be defined within and/or linked together via a breadcrumbs feature in the merchant interface. Breadcrumbs allow a merchant to place one or more items or tasks to be solved, collected, etc. by a customer in a particular order, usually leading to some sort of end stage where the customer can collect a prize/reward. This feature allows a merchant to foster loyal customer engagement through a type of scavenger hunt offered to certain groups and at certain times.

FIG. 15A shows a merchant's primary breadcrumb management screen. New breadcrumbs can be added using the “+” button at the upper right. Below this, a scrollable list of previously created breadcrumbs is available to the merchant, along with a status indicator, a breadcrumb date, and a toggle to deactivate breadcrumbs that are currently set. Each breadcrumb can be modified by selecting it on the scrollable list.

FIG. 15B illustrates the high-level definition options for a new breadcrumb. Available parameters include selecting who will get notification that the breadcrumb is “live” among the merchant's followers, what media item(s) are linked to this breadcrumb, definition of a Question/Answer item for this breadcrumb, definition of a collectible for this breadcrumb, and directions for the breadcrumb. Not all breadcrumbs need have all parameters defined, as will be shown below. A Publish button allows the breadcrumb to move to a set status (although it may not be “live” until a given date/date range is reached). An “Add New” button links this breadcrumb to a next breadcrumb, and pulls up a new breadcrumb definition screen (FIG. 15C), which is labeled “2^{nd}” in the upper right corner.

FIG. 15C allows definition of all parameters for a second breadcrumb in a series. A third can be added by again selecting the “Add New” button, and the merchant can left/right swipe to move between the ordered list of linked breadcrumbs. Due to this linking, a customer completing the first breadcrumb will be eligible to see the second breadcrumb or hint, or be notified when that breadcrumb goes live.

FIG. 15D shows an example of a screen accessible from the “Add Media” control of FIGS. 15B and 15C, allowing a merchant to either add an existing photo or take a new photo to a breadcrumb. Other media (not shown) such as video, audio, and AR elements can also be added via this control.

FIG. 15E illustrates an example of a screen accessible via the “Add Q & A” control of FIGS. 15B and 15C. In this example, the merchant can add a question and multiple-choice answers to a question to be presented to a customer reaching this breadcrumb. Buttons allow the merchant to set the correct answer. When a merchant selects any of these fields, they are presented with a dialog (FIG. 15F) to create the question/answer selected. At any point while editing the screen of FIG. 15E, the merchant may select one of the answer choices as the correct answer, as shown in FIG. 15G.

FIG. 15H shows the screen accessible by a merchant by selecting the “Add Directions” prompt in FIG. 15B or 15C. In this screen, the merchant may enter instructions/hints on a location for following the breadcrumbs.

FIG. 15I shows a screen accessible by the merchant to add a description of the breadcrumb, which will be shown to a consumer in their AR Breadcrumb View.

FIG. 15J shows a screen accessible to a merchant to manage/add collectibles. These can be managed and created separate from a breadcrumb, or accessed from FIG. 15B or 15C by selecting the “Add Collectibles” prompt in FIG. 15B or 15C. If accessed in the latter manner, a new or existing collectible can be selected and attached to the current breadcrumb.

FIG. 15K shows a Create Collectible dialog accessed from the “+” button of FIG. 15J. In this dialog, different types of collectibles can be added for a follower to “collect” by completing the associated breadcrumb task. As shown, the collectible could be digital art, an event coin, memorabilia, or an NFT (Non Fungible Token). It could also be one of the other vouchers and rewards that the system 108 allows a merchant to create and manage.

FIG. 15L shows a dialog entered by selecting the “Art” prompt of FIG. 15K, allowing the merchant to select art stored on or accessible from the device as the collectible. The system 108 may require administrative verification to create a collectible. Similar dialogs are enabled for other types of enabled collectibles.

FIG. 15M shows a dialog for creating a description for a collectible.

Once a user has completed all desired parameters for a breadcrumb, they can choose to publish the breadcrumb (store it to the system 108 for dissemination to selected followers). FIG. 15N presents the merchant with an ability to automatically set run dates for the breadcrumb. The merchant may choose not to set a run date, in which case the breadcrumb can publish immediately and remain active for an indeterminate period, until the merchant deactivates it. Otherwise, the merchant can select the “Add End Date” control, moving to the calendar screen shown in FIGS. 15O and 15P. In the calendar screen, the merchant may select a range of run dates (FIG. 15O) or a single run date (FIG. 15P), as desired. Based on these instructions, the system 108 determines when the breadcrumb can be accessed/followed by users. For instance, a first breadcrumb could be made available next Tuesday, and a second linked breadcrumb could be made available next Wednesday, encouraging followers to visit every day to “earn” the next breadcrumb and advance towards a collectible.

FIG. 15Q allows a merchant to set an AR location for the breadcrumb, based e.g., on a location and viewpoint of the merchant's device. In one embodiment, followers can “see” the breadcrumb in their AR view if they have followed the trail up to this point.

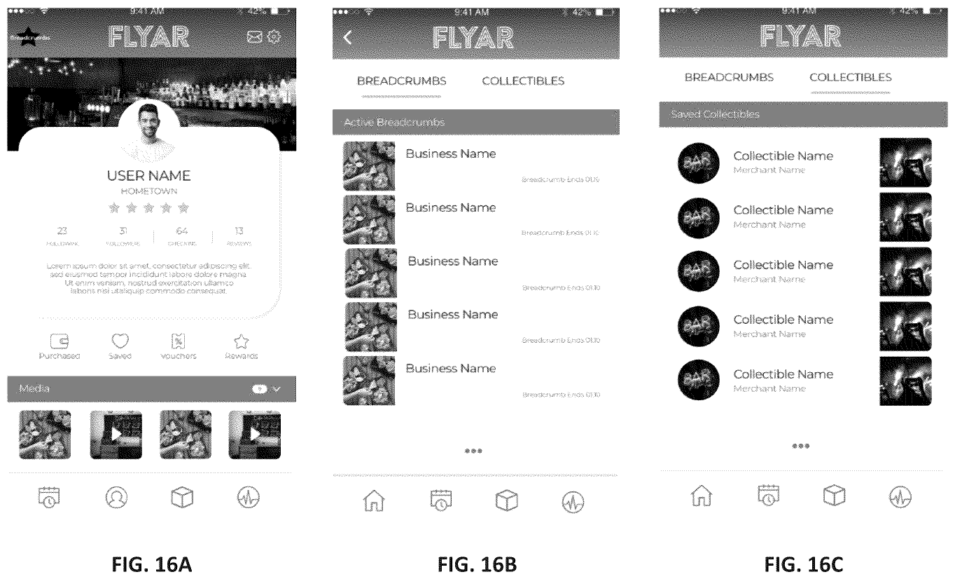

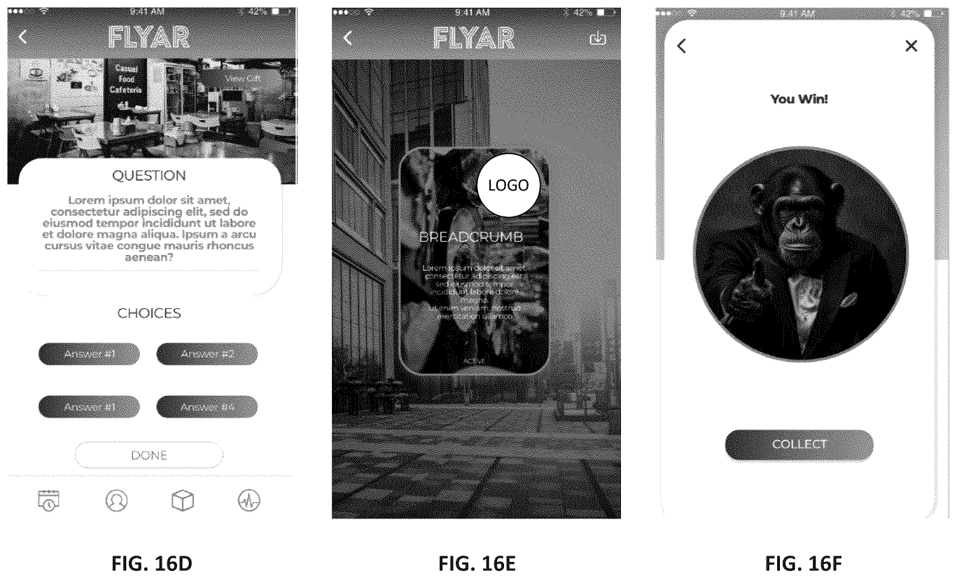

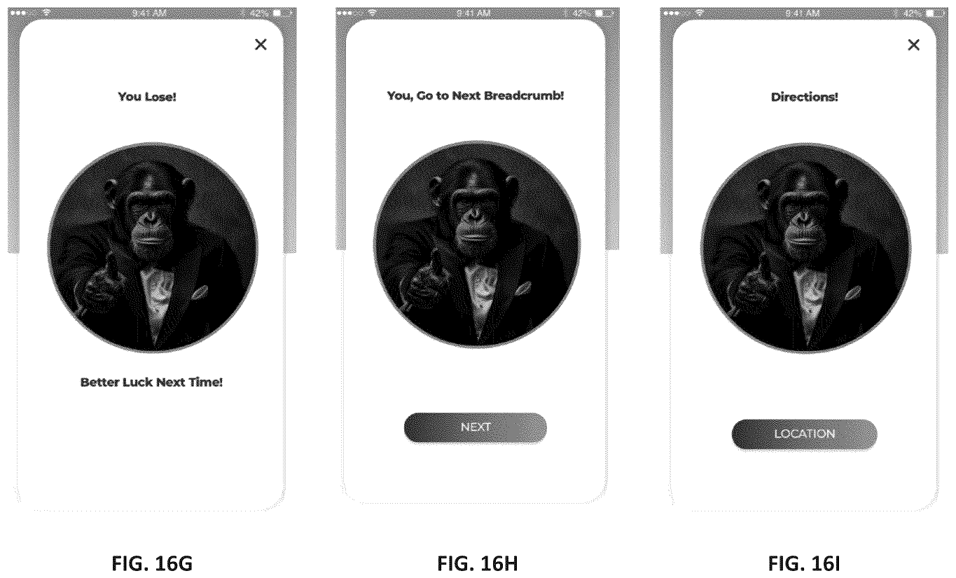

FIGS. 16A-16I illustrate some of the breadcrumb capabilities of the system 108 as shown to consumers. FIG. 16A shows a consumer home screen, as shown and described previously, with an icon in the upper left that allows the consumer to access breadcrumbs. Selecting this icon takes the consumer to a main breadcrumb screen, which the system 108 assembles from the database for that user by examining which merchants have published, active breadcrumbs targeting this consumer. The active breadcrumbs screen displays a scrollable list of these breadcrumbs, organized by merchant and/or by end time (e.g., breadcrumbs expiring soonest on top). The consumer can also select the “Collectibles” tab at the top of the display to show instead (FIG. 15J) a list of saved (collected/earned) collectibles by merchant.

When a consumer selects one of the active breadcrumbs from FIG. 16B, they are taken to an appropriate display/description for that breadcrumb. For instance, when the breadcrumb is/contains a question/answer item, the consumer may be served the question and answer selections as set by the merchant (FIG. 16D), and asked to select and enter a choice. When the breadcrumb contains an AR find-the-breadcrumb task, the consumer may be presented with an AR screen and hints to locating the breadcrumb (FIG. 16E). Upon successfully completing a task such as in FIG. 16D or 16E, the consumer is shown a “You Win!” pop-up (FIG. 16F), with an ability to collect the breadcrumb and/or a collectible attached to that breadcrumb. When the consumer fails at the task, they may be shown, e.g., a “You Lose” pop up with an encouragement to play again (FIG. 16G). When the consumer achieves the current breadcrumb, but it is attached to a following breadcrumb, they may be shown an invitation (FIG. 16H) to proceed to the next breadcrumb by selecting “Next”. If the next breadcrumb is not yet available, the consumer may be told when it will go live. If the next breadcrumb is available, they may be shown, e.g., a location hint (FIG. 16I) to start the process of collecting the next breadcrumb in the trail.

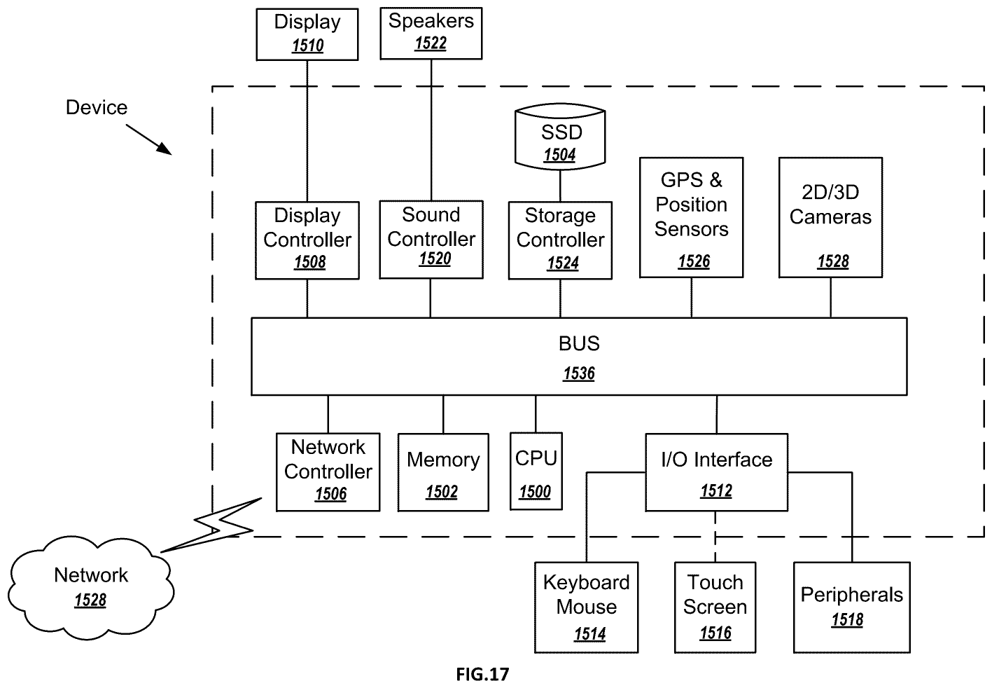

Next, a hardware description of a computing device, mobile computing device, computing system, or server according to exemplary embodiments is described with reference to FIG. 17. The computing device, for example, may represent a merchant device 158a-d, a customer device 158a-c, e, or a component of AR server system 108. In FIG. 17, the computing device, mobile computing device, or server includes a CPU 1500, which performs the applicable processes described above. The process data and instructions may be stored in memory 1502, including non-transitory memory. The processing circuitry and stored instructions may enable the computing device to perform, in some examples, the methods described for a merchant AR app 102, a customer AR app 104, one or more functions of AR server system 108, and/or one or more functions of database 110. These processes and instructions may also be stored on a storage medium disk 1504 such as a hard drive (HDD), solid state drive (SSD), or portable storage medium, or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, HDD, SSD, or any other information processing device with which the computing device, mobile computing device, or server communicates, such as a server or computer. The storage medium SSD 1504, in some examples, may store a portion of the contents of the data repository 110 of FIG. 1, as well as the data maintained by the merchants 102, customers 104, and/or administrators of AR server system 108.

Further, a portion of the claimed advancements may be provided as a utility application, background daemon, or component of an operating system, or combination thereof, executing in conjunction with CPU 1500 and an operating system such as Microsoft Windows 7, 8, 10, UNIX, Solaris, LINUX, Apple MAC-OS and other systems known to those skilled in the art.

CPU 1500 may be a Xeon or Core processor from Intel of America or an Opteron processor from AMD of America, an Apple Silicon processor, an ARM processor, or may be other processor types that would be recognized by one of ordinary skill in the art. Alternatively, the CPU 1500 may be implemented on an FPGA, ASIC, PLD or using discrete logic circuits, as one of ordinary skill in the art would recognize. Further, CPU 1500 may be implemented as multiple processors cooperatively working in parallel to perform the instructions of the inventive processes described above.

The computing device, mobile computing device, or server in FIG. 17 also includes a network controller 1506 for interfacing with one or more networks 1528. As can be appreciated, the network 1528 can be a public network, such as the Internet, or a private network such as an LAN or WAN network, a cellular network, or any combination thereof and can also include PSTN or ISDN sub-networks. The network 1528 can also be wired, such as an Ethernet network, or can be wireless such as a cellular network including EDGE, 3G, 4G, and 5G wireless cellular systems. The wireless network can also be Wi-Fi, Bluetooth, or any other wireless form of communication that is known. The network 1528, for example, may support communications between the AR server system 108 and any one of the merchant or customer devices.

The computing device, mobile computing device, or server further includes a display controller 1508 for interfacing with display 1510. A general purpose I/O interface 1512 interfaces with a keyboard and/or mouse 1514 in some embodiments, as well as a touch screen panel 1516 on or separate from display 1510 in some embodiments. General purpose I/O interface 1512 also connects to a variety of peripherals 1518 including printers and scanners. The display controller 1508 and display 1510 may enable presentation of user interfaces for submitting requests to the AR server system 108.

A sound controller 1520 is also provided in the computing device, mobile computing device, or server, to interface with speakers/microphone 1522 thereby providing sounds and/or music.

The devices used by merchants and customers typically include one or more 2D/3D cameras that assist the apps 102 and 104 with AR functions. Likewise, these devices can use, in addition to scene detection provided by the 2D/3D cameras 1528, GPS, orientation, compass, acceleration, and WiFi sensors 1526 to provide an app 102 or 104 with location assistance.

The general-purpose storage controller 1524 connects the storage medium SSD 1504 with communication bus 1536, which may interconnect some or all of the components of the computing device, mobile computing device, or server. In some devices, such as a smartphone, many of the CPU, interface, bus, and controller functionalities may be combined in a “system on a chip” (SoC). A description of the general features and functionality of the display 1510, keyboard and/or mouse 1514, as well as the display controller 1508, storage controller 1524, network controller 1506, sound controller 1520, and general purpose I/O interface 1512 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a cloud computing system.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 17, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the computing devices described herein may interface with a cloud computing environment, such as Google Cloud Platform™ or Amazon Web Services (AWS) to perform at least portions of methods or algorithms detailed above. The processes associated with the methods described herein can be executed on a computation processor, such as the Google Compute Engine or AWS by a data center. The data center, for example, can also include an application processor, such as the Google App Engine, that can be used as the interface with the systems described herein to receive data and output corresponding information. The cloud computing environment may also include one or more databases or other data storage, such as cloud storage and a query database. In some implementations, the cloud storage database such as the Google Cloud Storage, may store processed and unprocessed data supplied by systems described herein. For example, candidate AR data and customer and merchant data may be maintained by the AR server system 108 of FIG. 1 in a database structure.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

While certain embodiments have been described, these embodiments have been presented by way of example only and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. An augmented reality system comprising:
a network system in communication with a plurality of mobile computing devices, each of the plurality of mobile computing devices executing at least one of a first application and a second application, the network system comprising
a merchant data repository,
a user data repository, and
a merchant data server;
a first application, storable in a non-transitory memory of and executable on each of a first plural set of the plurality of mobile computing devices, the first application, during execution on any given first device of the first plural set of mobile computing devices, causing the given first device to
generate a display interface to accept, from a given merchant of a plurality of merchants, one or more associated merchant media files,
each merchant media file associated by the given merchant with
a display location definition comprising at least one location tied to that file and
a display conditions definition comprising one or more parameters defining conditions under which the merchant media file is to appear as an augmented reality object, and
based on the given merchant verifying its identity to the network system, upload, to the merchant data repository, each of the one or more associated merchant media files accepted through the interface along with the associated display location definition and display conditions definition for that merchant media file; and
a second application, storable in a non-transitory memory of and executable on each of a second plural set of the plurality of mobile computing devices, the second application, during execution on any given second device of the second plural set of mobile computing devices, causing the given second device to
communicate via a wireless network with the network system to
verify, to the network system, a user of the given device that has an account associated with the user data repository,
send, to the network system, location data for the given device, and
receive, from the network system, one or more merchant media files from the merchant data repository, the received merchant media files selected based on a match between the location data, user information for the user, and the display location definition and display conditions definition for a given merchant media file, and
operate an augmented reality module to incorporate data or an image associated with at least one of the one or more received merchant media files on a visual display of one of the mobile computing devices so that the data or an image is visible on the display contemporaneously with a scene associated with the location of the mobile computing device.

2. The system of claim 1, wherein the first and second applications comprise sections of a single application package.

3. The system of claim 1, wherein at least one of second set of devices comprises two or more connected devices, wherein one of the two or more connected devices comprises a wearable headset or glasses comprising a viewpoint camera to collect visual data representing a view detected by the camera.

4. The system of claim 3, wherein another of the two or more connected devices provides communication with the network system.

5. The system of claim 1, wherein at least a subset of the merchant media files are created at least in part by the first application.

6. The system of claim 1, wherein the merchant data server comprises a ranking engine to select the received merchant media files based on output from an artificial intelligence model trained on data associated with past interactions of users with the system.

7. The system of claim 1, wherein the first application is configured to accept, for association with a given merchant media file, display location definition and one or more parameters for user interaction with an overlay of the given merchant media file according to the display location definition.

8. The system of claim 7, wherein the one or more parameters for user interaction specify display of a user-manipulable control to play and/or pause playback of a media object.

9. The system of claim 7, wherein the one or more parameters for user interaction specify display of a user-manipulable control to purchase a merchant offering associated with the merchant media file.

10. The system of claim 9, wherein the one or more parameters further comprise a limitation on use of the user-manipulable control.

11. The system of claim 7, wherein the one or more parameters for user interaction specify display of a user-manipulable control to access a merchant offer associated with the merchant media file.

12. The system of claim 11, wherein the one or more parameters further comprise a limitation on the use of the user-manipulable control.

13. The system of claim 12, wherein the merchant offer comprises a merchant-defined voucher.

14. The system of claim 7, wherein the one or more parameters for user interaction specify a breadcrumb in a series of linked breadcrumbs.

15. The system of claim 1, wherein the user is a first user,
the user data repository is comprised of data from at least the first user and a second user, and
the one or more parameters defining conditions under which the merchant media file is to appear as an augmented reality object is based at least partially on the second user's interaction data.

16. The system of claim 1, wherein the merchant media file is to appear as an augmented reality object to both the first user and the second user.

17. The system of claim 1, wherein the user information comprises at least one user preference.

18. The system of claim 1, wherein the display conditions definition comprises temporal conditions, the time of day, or the day of week.

19. The system of claim 1, wherein the user information is comprised of feedback from the user.

20. A method for displaying personalized augmented reality content to a customer, comprising the steps of:
storing a merchant data repository on a merchant data server, wherein
the merchant data repository comprises merchant identity data for at least one merchant and at least one merchant media file associated with the at least one merchant,
selecting a location to display the at least one merchant media file associated with at least one merchant, the location comprising at least one location tied to the at least one merchant media file,
creating a display conditions definition comprising one or more parameters defining conditions under which the at least one merchant media file is to appear as an augmented reality object,
locating a mobile computing device associated with at least one customer proximate the location to display data associated with the at least one merchant media file associated with the at least one merchant,
receiving customer data about the at least one customer, comprising customer identity data,
based on the display conditions definition and the customer data, sending the at least one merchant media file to the mobile computing device associated with the at least one customer,
displaying the at least one merchant media file as an augmented reality object on a visual display of the mobile computing device associated with the at least one customer.
